(19) United States
(12) Patent Application Publication
(10) Pub. No.: US 2026/0137573 A1
(43) Pub. Date: May 21, 2026

(54) HEAT ENGINE ASSEMBLY AND AIR DUCTING SYSTEM FOR INCUBATOR

(71) Applicant: GE Precision Healthcare LLC, Waukesha, WI (US)

(72) Inventors: Rodney H. Nicoson, Eagle, WI (US); Helge B. Klockow, New Berlin, WI (US); Steven M. Falk, Baltimore, MD (US)

(21) Appl. No.: 18/951,497

(22) Filed: Nov. 18, 2024

(51) Int. Cl. A61G 11/00

(52) U.S. Cl. CPC A61G 11/00; A61G 2210/90

(57) ABSTRACT

Described herein are systems and methods for operating and cleaning an incubator heating system. A heat engine assembly and an air ducting system of the incubator heating system are removably coupled to a base at a first end. The air ducting system comprises a first side duct, a second side duct, and a central duct, each having a vent opening. The heat engine assembly comprises an air mover positioned between a first heater and a second heater. The air mover is configured to pull air into the central duct, direct air from the central duct past each of the first heater and the second heater to heat the air, and direct heated air through and out of each of the first side duct and the second side duct.

### TECHNICAL FIELD

Embodiments of the subject matter disclosed herein relate to methods and systems for an incubator heating system, comprising a heat engine assembly and an air ducting system, that may be removably positioned in an incubator.

### BACKGROUND

Conventional incubators comprise a confined enclosure that is adapted to retain a subject (e.g., an infant) in a controlled environment. A convective heating system generates heated air to regulate temperature within the enclosure based on environmental demands of the subject. The heating system may include an electric heater configured to directly or indirectly heat the air, and an air moving device (e.g., a fan) configured to circulate the heated air. The convective heating system may be positioned below a subject support system (e.g., a mattress) of the incubator. In other examples, the incubator may include a coil heater positioned below and/or integrated in the subject support system. Conventional incubator heating systems may demand an undesirably long and complex process for cleaning and disinfection of the incubator and elements thereof. For example, positioning the air moving device and heater in the bottom of a chassis of the incubator demands that multiple small and/or complex parts be removed from the incubator in order to remove the air moving device and the heater so that the incubator and its parts may be cleaned and disinfected. An incubator having a coil heater may demand removal of the subject support system from the incubator for cleaning, and may further demand a detailed and complex cleaning procedure so as to not degrade the incubator heating system.

### BRIEF DESCRIPTION

In one embodiment, an incubator heating system includes an air ducting system and a heat engine assembly that are removably positioned in a base. The heat engine assembly is removably coupled to the base at a first end. The base includes a fresh air inlet at a second end, opposite the first end. The air ducting system comprises a first side duct, a second side duct, and a central duct, each of which include a vent opening. Each duct of the air ducting system extends at least partially along a base length of the base between the first end and the second end. The heat engine assembly comprises an air mover, such as a fan, positioned between a first heater and a second heater along a first axis that is perpendicular to the base length of the base. The air mover is configured to pull air into the central duct via the fresh air inlet and vent holes of the central duct, direct air from the central duct past each of the first heater and the second heater to heat the air, and direct heated air through each of the first side duct and the second side duct and out of each of the first side duct and the second side duct through vent holes of the respective side duct.

The incubator heating system is configured to be easily removable from the base (e.g., a base of an incubator) to be cleaned. A method for cleaning an incubator that includes the incubator heating system comprises removing the heat engine assembly and the air ducting system from a first end (e.g., the end to which the heat engine assembly is removably coupled to the base) of the incubator. The heat engine assembly and the air ducting system may be removed from the incubator without removing a subject support system of the incubator. The method further includes cleaning the heat engine assembly and the air ducting system, and inserting the heat engine assembly and the air ducting system into the incubator via the first end.

It should be understood that the brief description above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The present disclosure will be better understood from reading the following description of non-limiting embodiments, with reference to the attached drawings, wherein below:

FIG. 1 is a side view of an exemplary incubator;

FIG. 2 is a schematic diagram of an exemplary incubator heating system for an incubator, such as the incubator of FIG. 1;

FIG. 3 is a first perspective view of an example of the incubator heating system of FIG. 2;

FIG. 4 is a second perspective view of the incubator heating system;

FIG. 5 is a third perspective view of the incubator heating system;

FIG. 6 is a perspective view of an exemplary heat engine assembly of the incubator heating system;

FIG. 7 is a perspective view of an exemplary flat tray of the incubator heating system;

FIG. 8 is a first perspective view of an example of a side duct of the incubator heating system;

FIG. 9 is a second perspective view of the example of the side duct;

FIG. 10 is a first perspective view of an example central duct of the incubator heating system;

FIG. 11 is a second perspective view of the central duct;

FIG. 12 is a first perspective view of an exemplary air ducting system of the incubator heating system, including the side duct and the central duct;

FIG. 13 is a second perspective view of the air ducting system in a base;

FIG. 14 is a third perspective view of the air ducting system in the base;

FIG. 15 is a first perspective view of the base of the incubator heating system;

FIG. 16 is a second perspective view of an example base of the incubator heating system;

FIG. 17 is a first cross-sectioned view of the incubator heating system;

FIG. 18 is a second cross-sectioned view of the incubator heating system;

FIG. 19 is a third cross-sectioned view of the incubator heating system;

FIG. 20 is a fourth perspective view of the incubator heating system;

FIG. 21 is a fifth perspective view of the incubator heating system;

FIG. 22 is a flow chart of an exemplary method for operating an incubator heating system; and

FIG. 23 is a flow chart of an exemplary method for cleaning an incubator heating system.

### DETAILED DESCRIPTION

The following description relates to embodiments of an incubator heating system configured to increase a cleanability and reduce a demanded cleaning time of an incubator in which the incubator heating system is integrated. A heat engine assembly of the incubator heating system is coupled to a base of the incubator at a first end of the incubator, and may be easily removed from the incubator as a single piece with little to no removal of other pieces of the incubator (e.g., a subject support system). Positioning of the heat engine assembly in the rear of the incubator, rather than throughout the bottom of the incubator, allows for a less complex air ducting system of the incubator heating assembly to be arranged below the subject support system. The incubator heating system may further have an increased heating efficiency compared to conventional incubator heating systems, due to reduced heat losses provided by the air ducting system of the incubator heating assembly. The air ducting system may be configured to intake air from an environment external to the incubator, as well as recirculate and reheat air from an infant compartment of the incubator. Air may be heated by the heat engine assembly and output to the infant compartment via two side ducts of the air ducting system that extend at least partially along a base length of the base between the first end and the second end, and each side duct of the two side ducts includes a set of vents to fluidly couple (e.g., enable air flow between) the air ducting system and the infant compartment. The air ducting system described herein that is configured for use with the heat engine assembly may be similarly removed from the incubator to be cleaned without demanding removal of small parts. A cleaning and disinfection time demanded for the disclosed incubator heating system may be reduced compared to conventional incubator heating systems and incubators in which they are implemented. Cleaning of the heating element(s) and the air mover of the heat engine assembly is thus significantly easier compared to cleaning of conventional incubator heating systems.

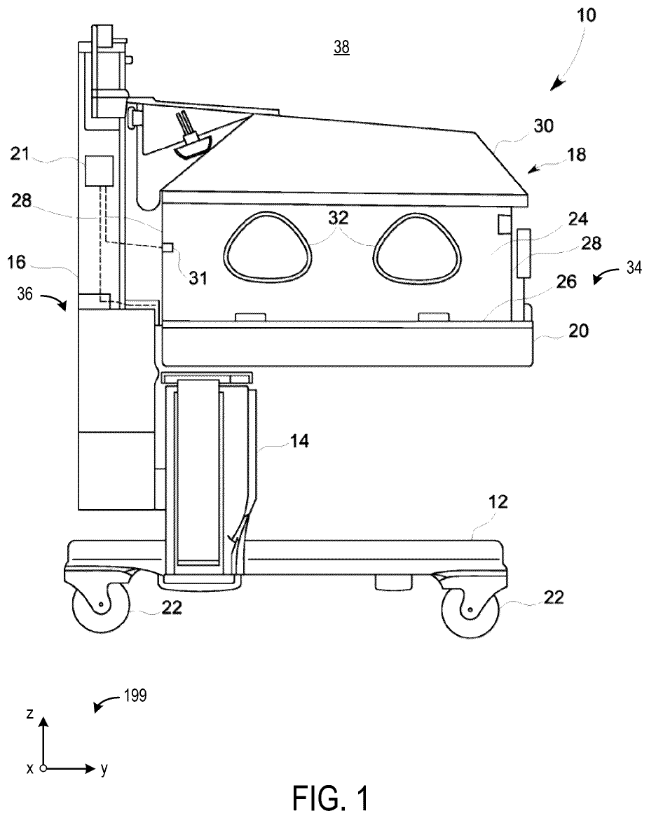

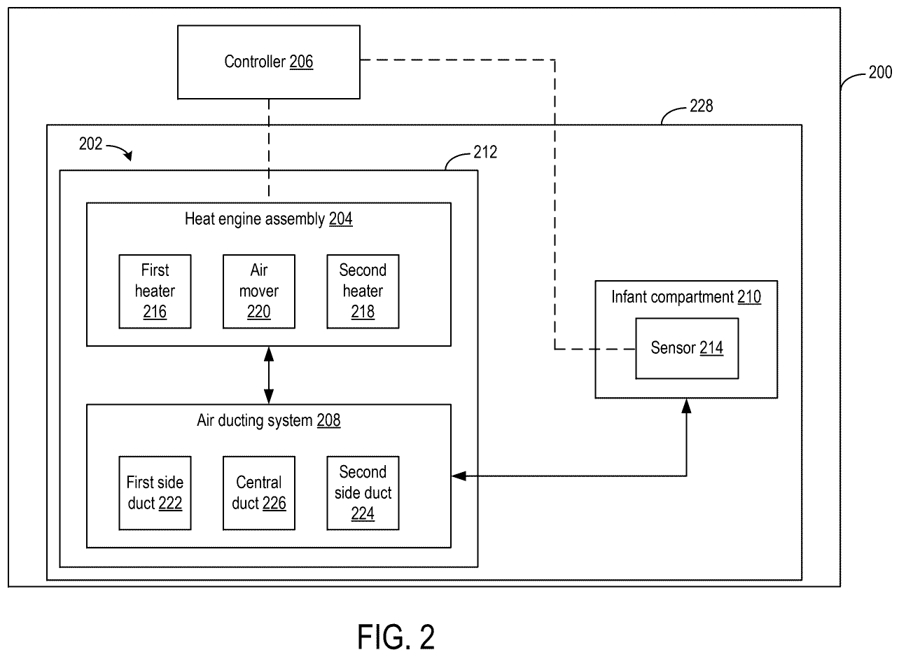

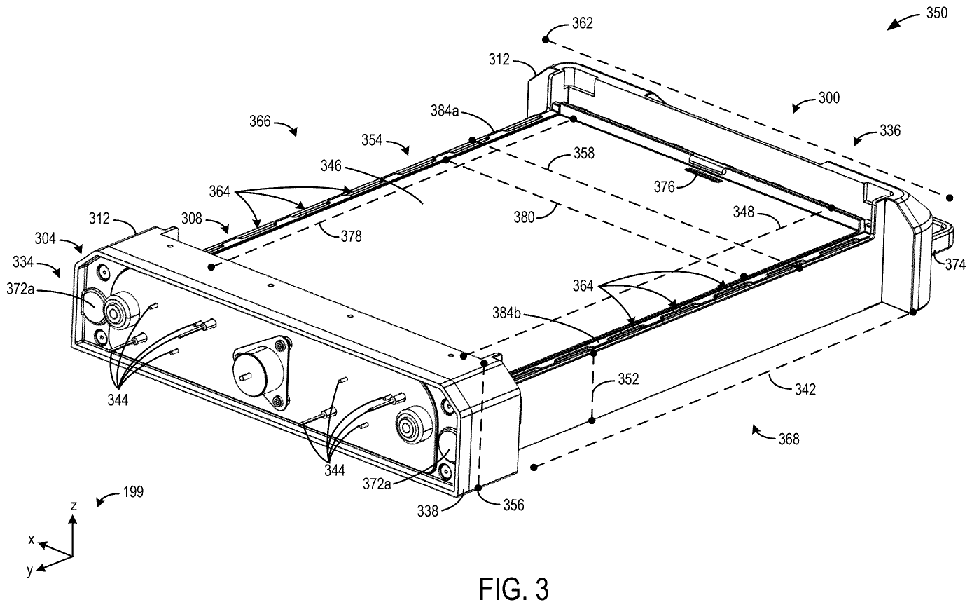

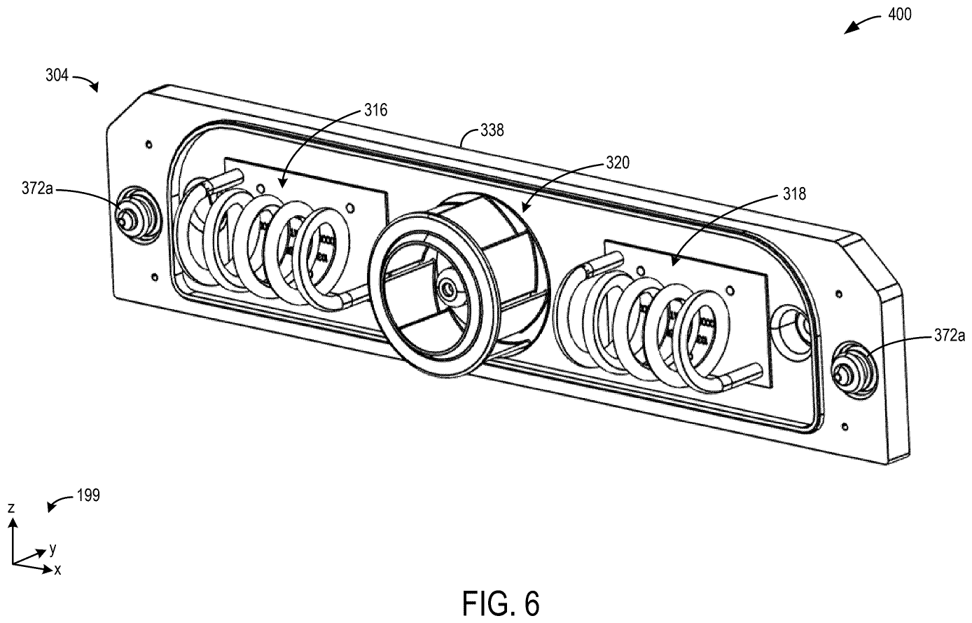

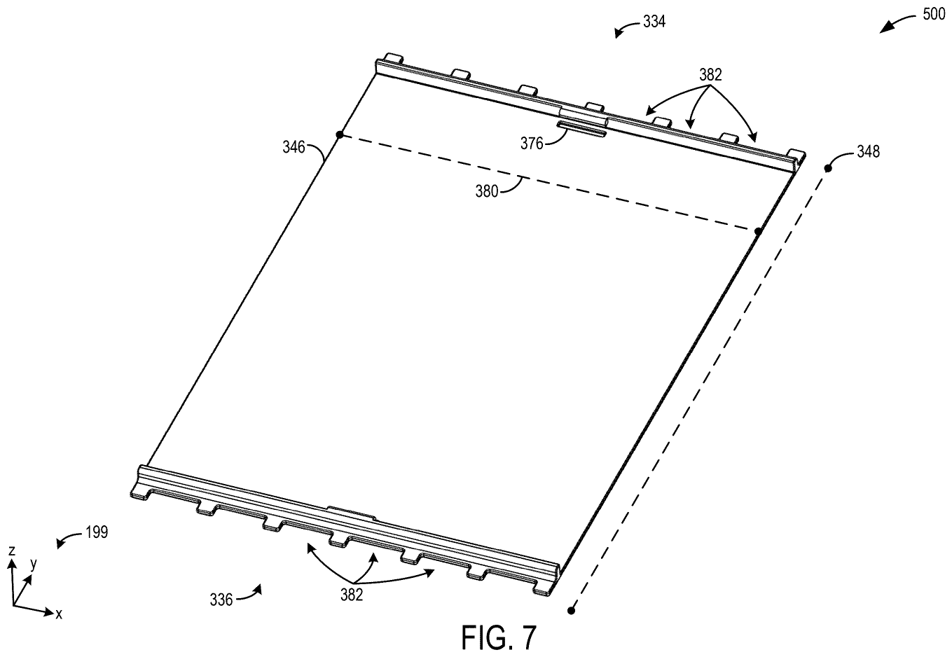

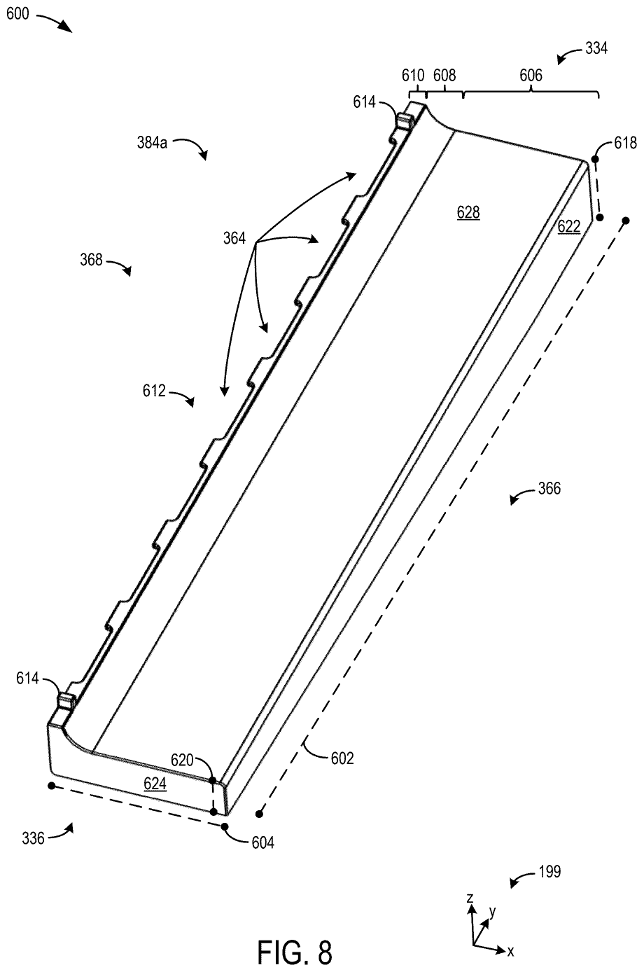

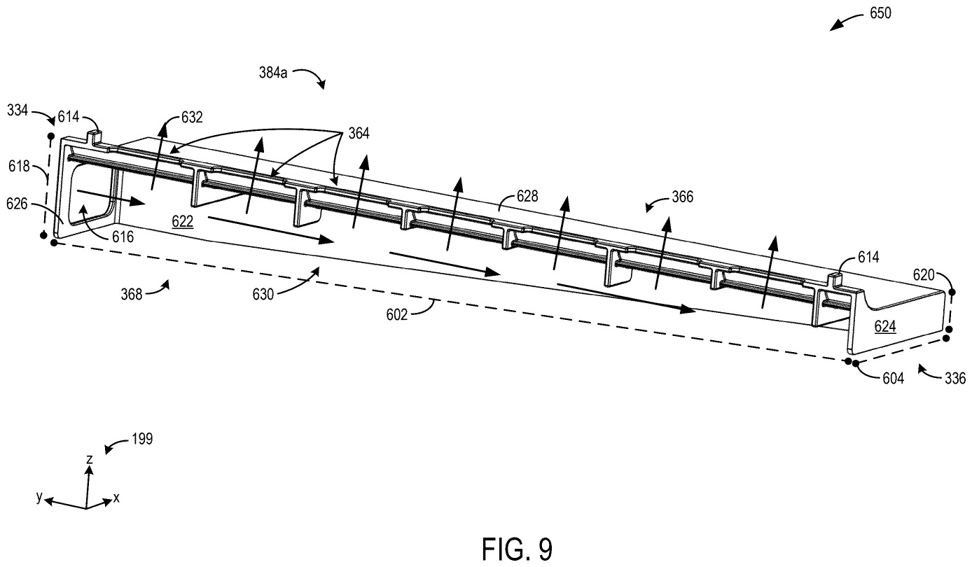

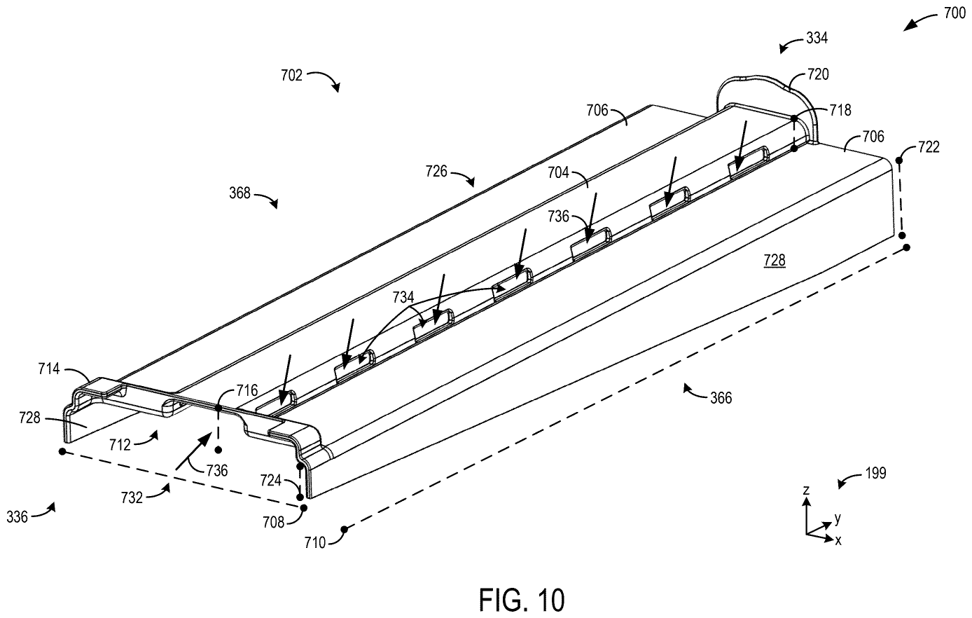

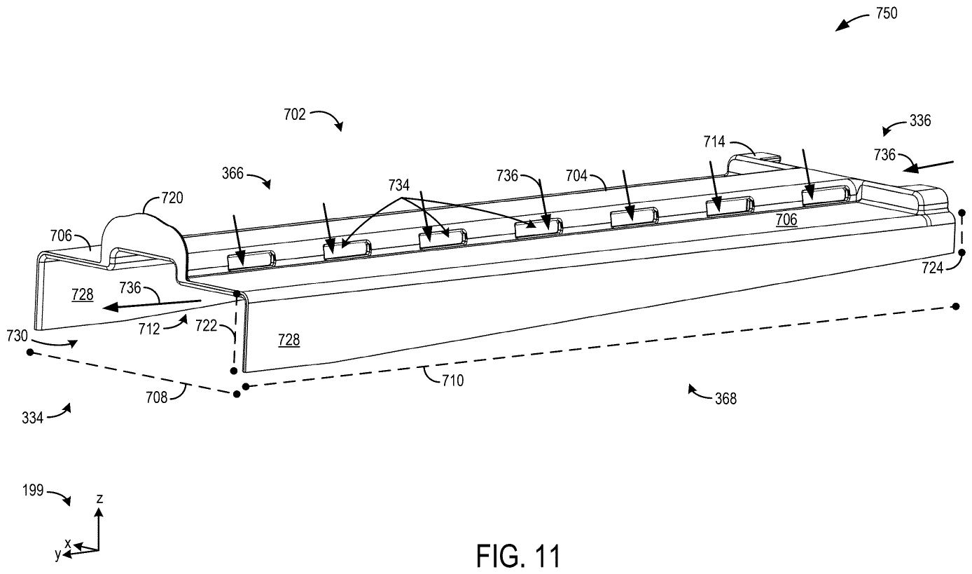

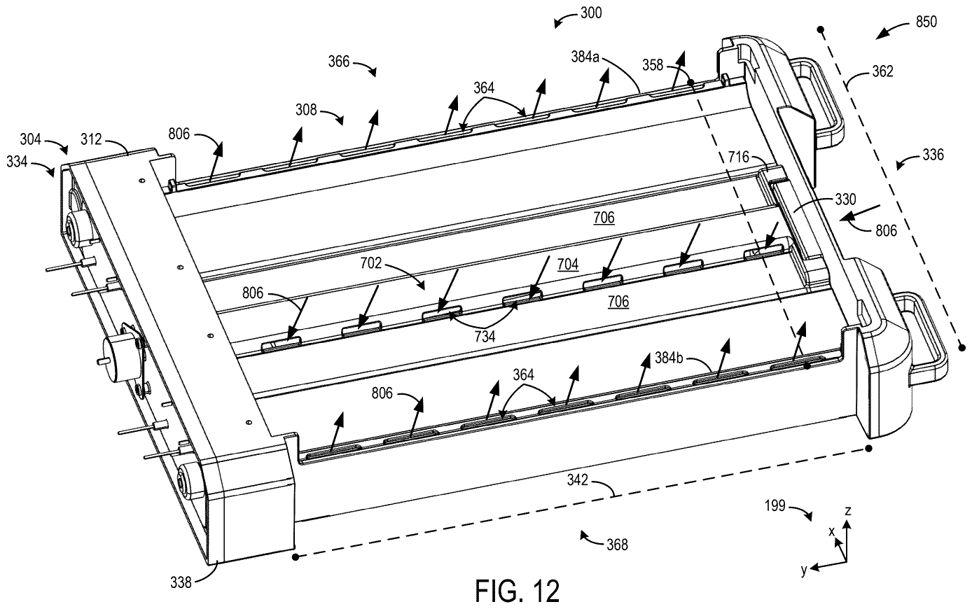

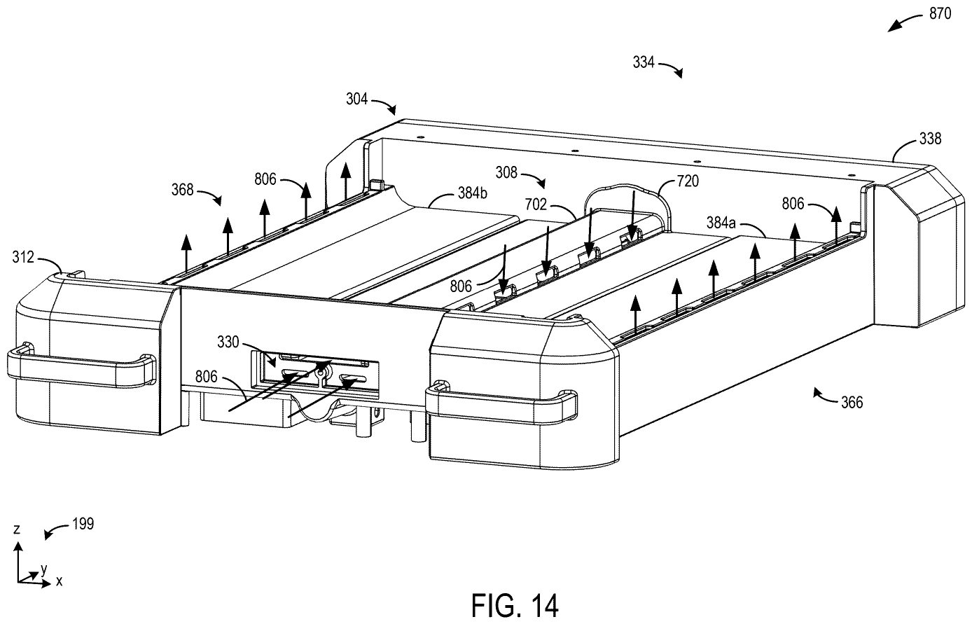

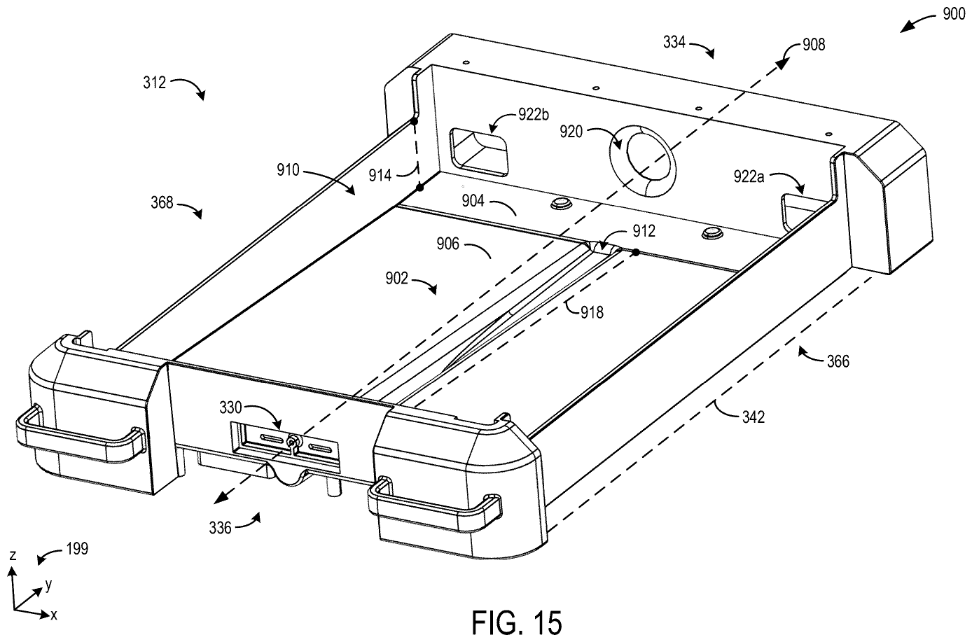

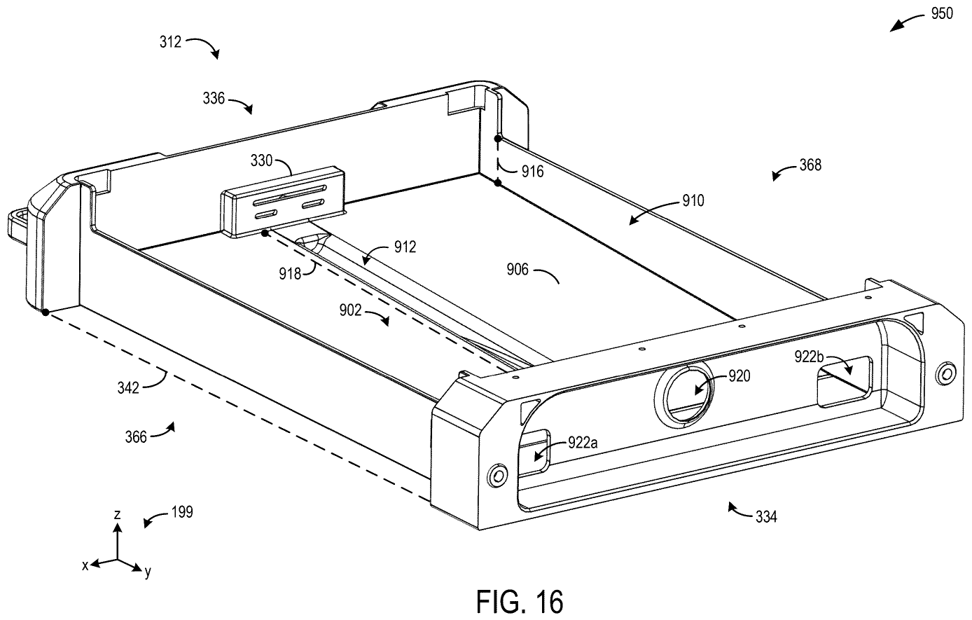

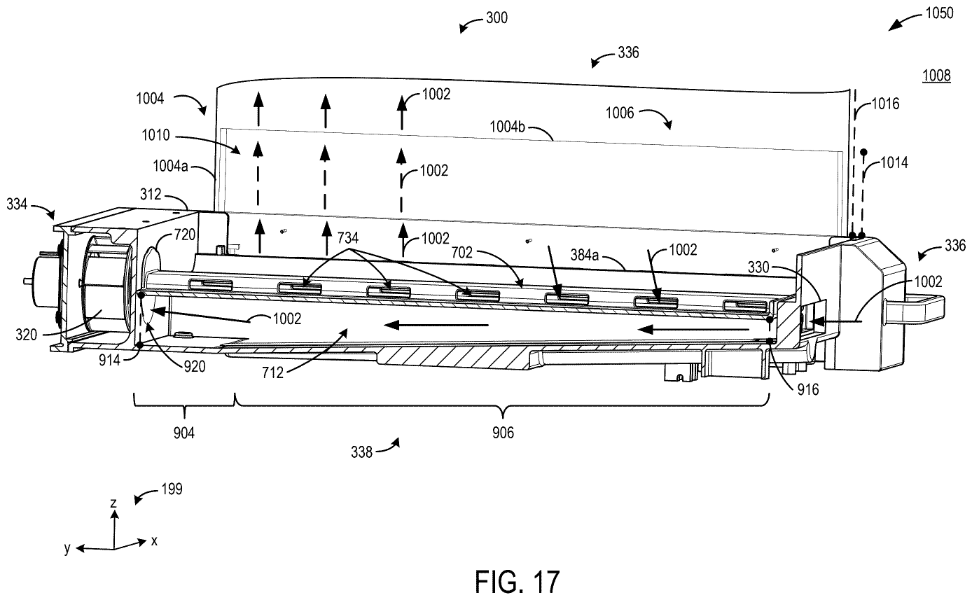

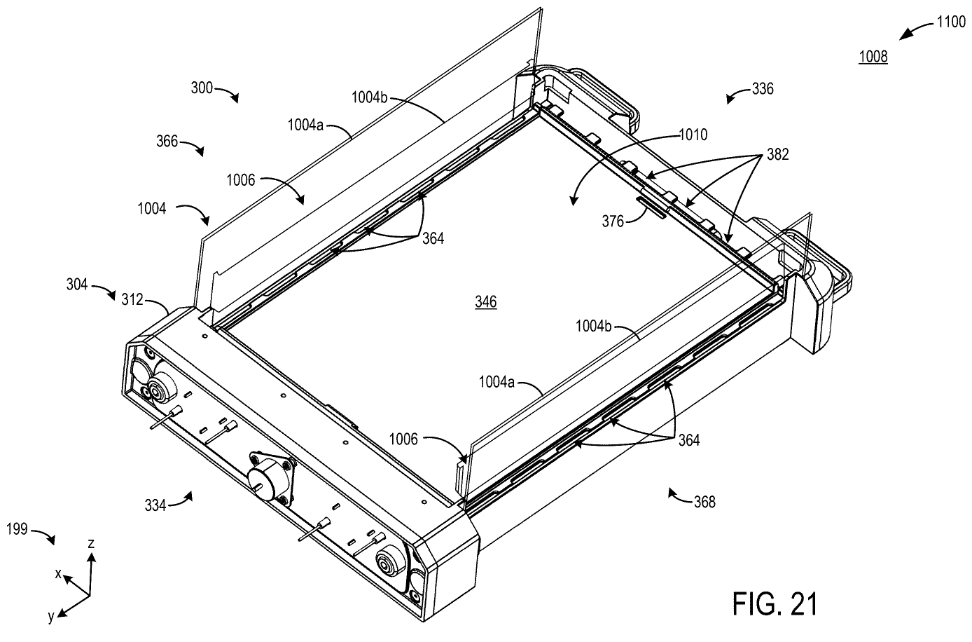

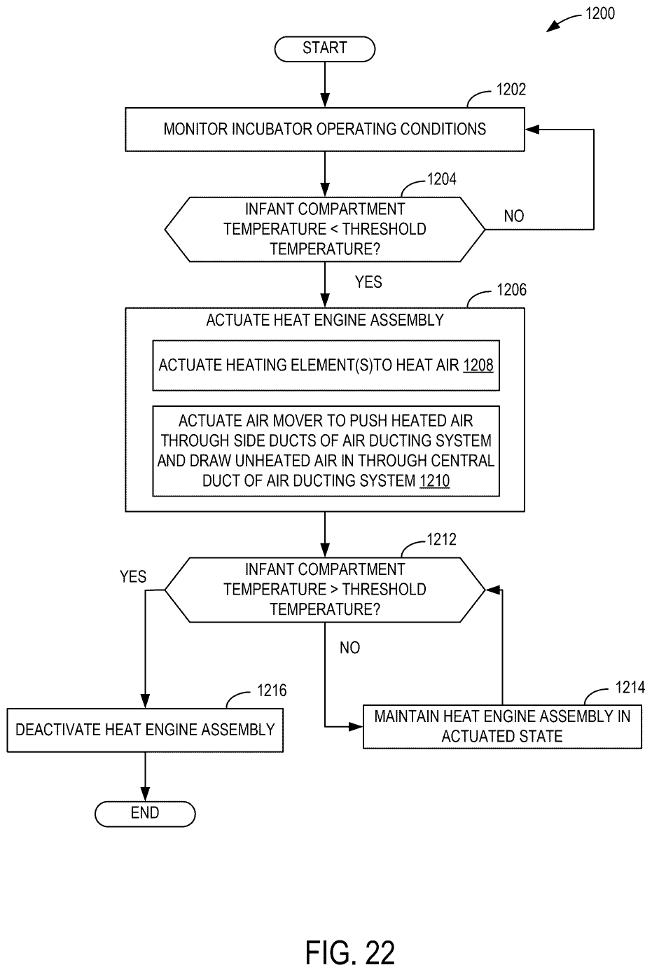

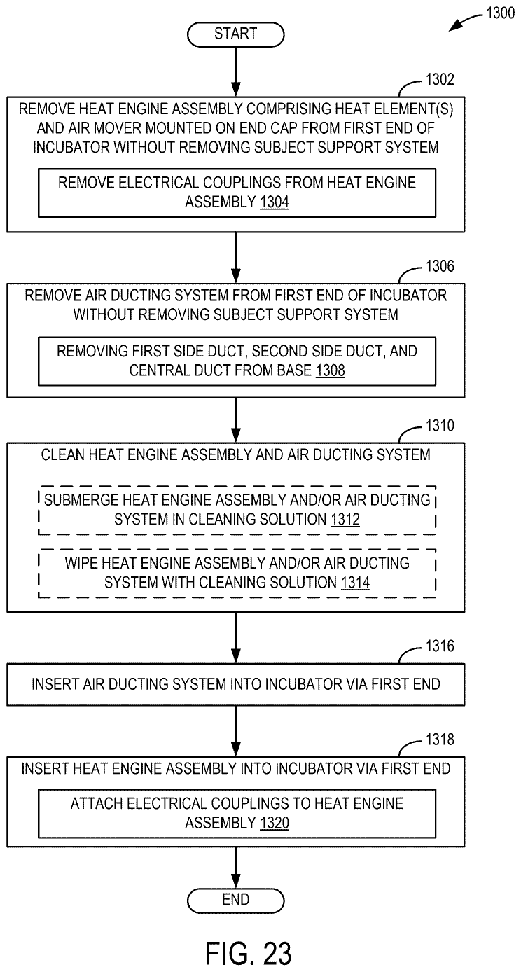

FIG. 1 shows an example of an incubator in which the disclosed incubator heating system may be integrated. FIG. 2 is a schematic diagram of the incubator heating system. FIGS. 3-5 show perspective views of the incubator heating system. FIG. 6 shows a perspective view of a heat engine assembly of the incubator heating system. FIG. 7 is a perspective view of a flat tray of the incubator heating system. FIGS. 8-9 show perspective views of a side duct, and FIGS. 10-11 show perspective views of a central duct, of an air ducting system of the incubator heating system. FIGS. 12-14 show perspective views of the incubator heating system with the flat tray removed to show the central duct and side ducts of the air ducting system in the base. FIGS. 15-16 show perspective views of a base of the incubator heating system in which the air ducting system, the heat engine assembly, and the flat tray are positioned. Air flow through the incubator heating system is shown in cross-section views thereof in FIGS. 17-20. FIG. 21 shows a perspective view of the incubator heating system, including walls of an infant enclosure. FIG. 22 is a flow chart of a method for operating an incubator heating system, and FIG. 23 is a flow chart of a method for cleaning an incubator heating system. For example, the methods of FIGS. 22 and 23 may be applied to the incubator heating system of FIGS. 1-21. FIGS. 1 and 3-21 are shown approximately to scale, although other relative dimensions may be used, if desired.

Referring to FIG. 1, a side view of an incubator 10 is shown in accordance with an embodiment. An axis system 199 is provided in FIG. 1, as well as FIGS. 3-20, for reference. The z-axis may be a vertical axis (e.g., parallel to a gravitational axis), the x-axis may be a lateral axis (e.g., horizontal axis), and the y-axis may be a longitudinal axis, in one example. However, the axes may have other orientations, in other examples. The incubator 10 may include a chassis 12, a vertical member 14, a vertical frame 16, an infant enclosure 18, an incubator heating system 20, and a controller 21. The chassis 12 may include one or more wheels 22 to facilitate translation of the incubator 10. The vertical member 14 is secured to the chassis 12, and the vertical frame 16 is secured to the vertical member 14.

The infant enclosure 18 defines an infant compartment 24. The infant compartment 24 provides a controlled environment where heat and humidity can be regulated to aid in the development and well-being of an infant (not shown) positioned in the infant compartment 24. The infant enclosure 18 may be mounted to the vertical member 14 and/or the vertical frame 16. The infant enclosure 18 includes a subject support system 26, a plurality of walls 28, a canopy 30, and a sensor 31. The subject support system 26 supports an infant positioned within the infant compartment 24. For example, the subject support system 26 may include a platform on which a mattress is placed. The walls 28 extend upwardly from a periphery of the subject support system 26. The walls 28 generally comprise a transparent plastic material. In some examples, the walls 28 may be two-paned walls. The walls 28 may define hand holes 32 to enable a caregiver to reach the infant within the infant compartment 24. The canopy 30 overlies the subject support system 26 and may comprise a transparent material that covers the upper peripheral edges of the walls 28. The sensor 31 may be connected to the controller 21 and disposed within the infant compartment 24. According to one embodiment, the sensor 31 comprises a thermal sensor adapted to measure the temperature within the infant compartment 24 and to transfer measured temperature data to the controller 21.

The incubator heating system 20 may be disposed immediately below the subject support system 26 as shown in FIG. 1. The incubator heating system 20 is pneumatically coupled with the infant compartment 24 such that thermal energy is transferable therebetween. As further described herein, the incubator heating system 20 comprises a heat engine assembly positioned in a base of the infant enclosure 18 at a first end 34 of the infant enclosure 18. As further described herein with respect to FIGS. 2-21, the heat engine assembly comprises a heat element that is configured to heat air, and an air mover (e.g., a fan) configured to facilitate transfer of heat from the heat element through air to selectively transfer heat to the infant compartment 24. The incubator heating system 20 further comprises an air ducting system that comprises a fresh air inlet, positioned at a second end 36 of the infant enclosure 18. The fresh air inlet is configured to drawn in air from an environment 38 that is external to the infant enclosure 18, where the air is to be heated by the heat engine assembly. The controller 21 may be operatively connected to the incubator heating system 20 to regulate heating system operation and thereby maintain a predetermined target temperature within the infant compartment 24.

In some examples, the infant compartment 24 may be configured to tilt and expose the incubator heating system 20, thus making the incubator heating system 20 and components thereof accessible for cleaning. For example, the infant compartment 24 may be coupled to the vertical frame 16 of the incubator 10 via a hinge or other mechanism that enables tilting of the infant compartment 24 with respect to the x-axis.

Conventional incubator heating systems may include air ducting systems and/or heat engine assemblies that are more complex than the incubator heating system described herein. For example, a conventional air ducting system may include a serpentine configuration that includes multiple switchbacks, curves, and/or angled changes in direction of one or more air ducts. The conventional air ducting system may be fixedly positioned in a base of the incubator. In further examples, the conventional air ducting system may be removably positioned in the base of the incubator and coupled to the base via one or more fasteners. Conventional heat engine assemblies may include heat pump water heaters, heat coils that extend beneath and/or throughout a surface area of the subject support system, and/or other heat elements that use multiple complex elements to heat the subject support system and/or air in the infant compartment. Cleaning of such conventional incubator heating systems may be time consuming, complex, and demand many detail-oriented steps. In some examples, cleaning conventional incubator heating systems may include removing and replacing one or more parts of the incubator and/or the incubator heating system. Methods for cleaning conventional incubator heating systems may demand removing, storing, and reinserting fastening devices such as screws used to couple elements of the incubator heating system to the incubator. Different elements of conventional incubator heating systems may demand different cleaning methods, where some but not all elements may be tolerant of disinfecting, sanitizing, and/or cleaning materials/methods. Described herein is an incubator heating system having a design that enables removal of and cleaning of the heat engine assembly and the air ducting system without removal of the subject support system. Further, the heat engine assembly may be easily removed and reattached to the incubator via coupling elements integrated in the heat engine assembly. The air ducting system may be slid into and out of the base of the incubator heating system without demand for fastening elements.

FIG. 2 is a schematic diagram of an incubator 200 that includes an incubator heating system 202. The incubator 200 may be an example of the incubator 10 of FIG. 1, and the incubator heating system 202 may be an example of the incubator heating system 20 of FIG. 1. In other examples, the heating system 202 may be compatible with an alternative incubator. Elements of the incubator 200 that are described with respect to FIG. 1 as having the same name are to be understood as being the same elements, and may not be reintroduced for brevity. The incubator 200 comprises an infant enclosure 228 that defines an infant compartment 210. The infant compartment 210 may include a sensor 214 positioned therein, where the sensor 214 is communicably coupled to a controller 206 and is configured to measure the temperature within the infant compartment 210 and transfer measured temperature data to the controller 206. The infant enclosure 228 further includes the incubator heating system 202, which is positioned beneath (e.g., with respect to a vertical axis, as described with respect to FIGS. 1, 3-20) and in fluidic communication with the infant enclosure 228. Dashed lines of FIG. 2 indicate communicative coupling of elements (e.g., a wired and/or a wireless coupling that enables transfer of data). Solid lines with arrows in FIG. 2 indicate air flow.

The incubator heating system 202 comprises a heat engine assembly 204 and an air ducting system 208 housed in a base 212. The heat engine assembly 204 comprises a heating element that is configured to heat air in an immediate vicinity of the heating element. For example, the heating element may heat air within 5 cubic inches of the heating element. In other examples, the heating element may heat air that is greater than 5 cubic inches of the heating element. The heating element may include a first heater 216 and a second heater 218 The first heater 216 and the second heater 218 may be a same type or different types of heating elements. In the example described herein with respect to FIGS. 3-20, each of the first heater 216 and the second heater 218 are heat coils. In other examples, one or more of the first heater 216 and the second heater 218 may be an electric heater that may be plugged into and powered by an electrical outlet. In further examples, the first heater 216 and/or the second heater 218 may be an infrared heater, a duct heater, a gas heater, and so on. The first heater 216 and the second heater 218 may alternatively be powered by other known power sources, such as for example solar cells, a generator, a battery, and so on.

The heat engine assembly 204 further comprises an air mover 220 that is configured to direct air through the incubator heating system 202 via the air ducting system 208. In the example of the heat engine assembly 204 described herein, the air mover is a fan. The air ducting system 208 may comprise a first side duct 222, a second side duct 224, and a central duct 226. The central duct 226 is positioned between the first side duct 222 and the second side duct 224, as shown in FIGS. 8-9. Each of the first side duct 222, the second side duct 224, and the central side duct 226 are configured with a vent opening that fluidly couples the air ducting system 208 to the infant compartment 210. For example, the vent opening may be one or more vent holes and/or slots.

The controller 206 is operably coupled to the incubator heating system 202, such that actuation of elements of the heat engine assembly 204 may be controlled by the controller 206. For example, a temperature of each of the first heater 216 and the second heater 218 may be independently and/or simultaneously controlled by the controller 206, where the controller actuates the first heater 216 and/or the second heater 218 to heat to a desired temperature. Further, the controller 206 may actuate the air mover 220 to direct air in a desired direction and/or at a desired speed. The controller 206 may regulate operation of the heat engine assembly 204 based in part on feedback from the sensor 214. For example, in response to the temperature within the infant compartment 210 (e.g., as detected and sent to the controller 206 by the sensor 214) being less than a threshold desired temperature, the controller 206 may actuate the first heater 216 and/or the second heater 218 to heat air, and may further actuate the air mover 220 to direct air throughout the incubator heating system 202 via the air ducting system 208. The threshold desired temperature may be, for example, a temperature at which infant development is supported (e.g., 99° F.). The air mover 220 may be actuated to intake air to be heated via a fresh air inlet of the base and a vent opening of the central duct 226. The air mover 220 may further direct air towards each of the first heater 216 and the second heater 218. As air flows past the first heater 216 and the second heater 218 (e.g., as air is directed by the air mover 220), the air may be heated (e.g., air is heated when the first heater 216 and/or the second heater 218 are actuated. Heated air is further directed into the first side duct 222 and the second side duct 224 by the air mover 220. Heated air flows out of the first side duct 222 and the second side duct 224 into the infant compartment 210 via a vent opening of each of the first side duct 222 and the second side duct 224. The controller 206 may operate the first heater 216 and/or the second heater 218, and the air mover 220, to transfer heat to the infant compartment 210 until feedback from the sensor 214 indicates a target temperature (e.g., equal to or greater than the threshold desired temperature) has been reached). Thereafter, the controller 206 may operate the heat engine assembly 204 in a manner adapted to maintain the target temperature within the infant compartment 210. In this way, the heat engine assembly 204 may be selectively actuated to adjust and/or maintain the temperature in the infant compartment 210 at a desired temperature without demanding user input. The controller 206 may regulate a rate of thermal transfer to the infant compartment 210 by adjusting the speed of the air mover 220 and/or the temperature of the first heater 216 and/or the second heater 218.

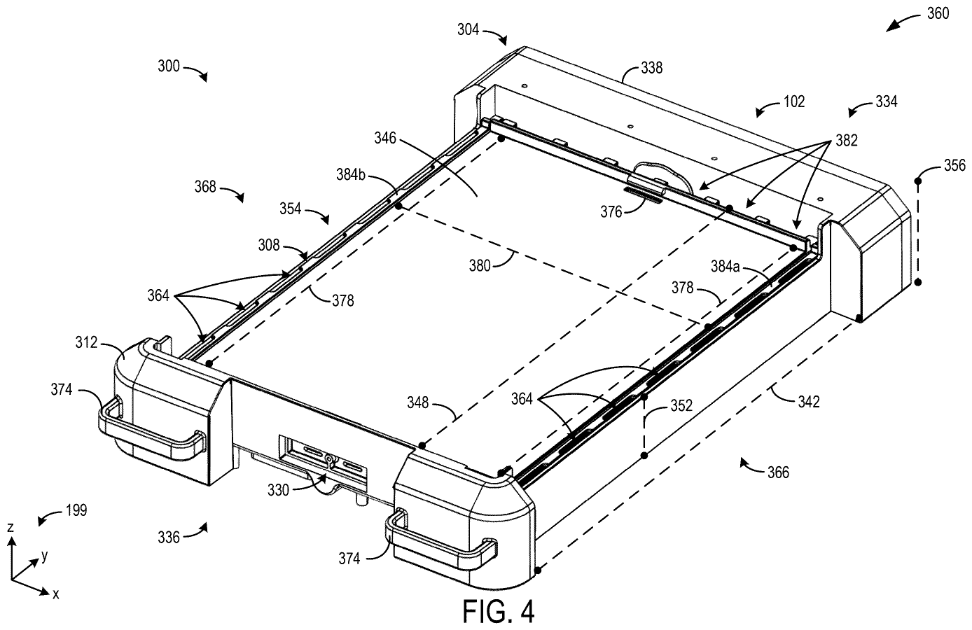

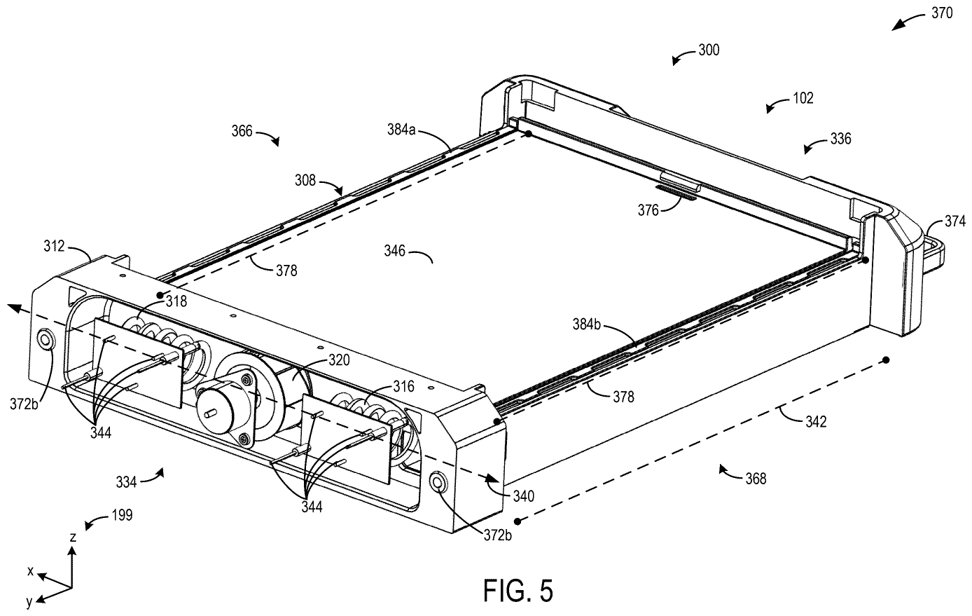

FIGS. 3-5 show perspective views of an incubator heating system 300. The incubator heating system 300 may be an example of the incubator heating system 202 of FIG. 2, and may further be implemented in the incubator 10 of FIG. 1. Some elements of the incubator heating system 300 that are described with respect to the incubator heating system 202 of FIG. 2 are not shown in the views of FIGS. 3-5, though it is to be understood that the incubator heating system 300 may include such elements. Further, some elements of the incubator heating system 202 of FIG. 2 that are included in the incubator heating system 300 of FIGS. 3-5 are similarly numbered (e.g., the base 212, a base 312). FIG. 3 shows the incubator heating system 300 in a first perspective view 350, FIG. 4 shows a second perspective view 360, and FIG. 5 shows a third perspective view 370.

The incubator heating system 300 comprises a base 312 in which a heat engine assembly 304 and an air ducting system 308 are removably positioned. The heat engine assembly 304 may be an example of the heat engine assembly 204 of FIG. 2. The air ducting system 308 may be an example of the air ducting system 208 of FIG. 2. The base 312 has a first height 352 in a middle portion 354 of the base 312, and a second height 356 at each of a first end 334 and a second end 336, opposite the first end 334. The second height 356 may be greater than the first height 352. Further, the base 312 may have a first width 358 in the middle portion 354, and a second width 362 at each of the first end 334 and the second end 336. The second width 362 may be greater than the first width 358. The first width 358 and the second width 362 are perpendicular to the base length 342. The base 312 may have handles 374 at the second end 336. The heat engine assembly 304 is removably coupled to the base 312 at the first end 334 via an end cap 338. In other examples, the heat engine assembly 304 may be fixedly coupled to the base 312. As shown in FIG. 4, the base 312 includes a fresh air inlet 330 at the second end 336 that is opposite the first end 334.

The heat engine assembly 304 includes the end cap 338 that is removably coupled to the base 312. The end cap 338 includes coupling elements 372a that enable selective coupling of the heat engine assembly 304 to the base 312 of the incubator heating system 300. The coupling elements 372a may include one or more fasteners, such as screws, press fit couplings, and so on. The heat engine assembly 304 may be removed (e.g., uncoupled) from the incubator heating system 300 by uncoupling the end cap 338, and thus elements of the heat engine assembly 304 that are permanently and/or removably coupled to the end cap 338, from the base 312. The heat engine assembly 304 may be removed (e.g., uncoupled) from the base 312 during execution of a method for cleaning the incubator heating system 300. Details of an example method for cleaning the incubator heating system 300 are described with respect to FIG. 23.

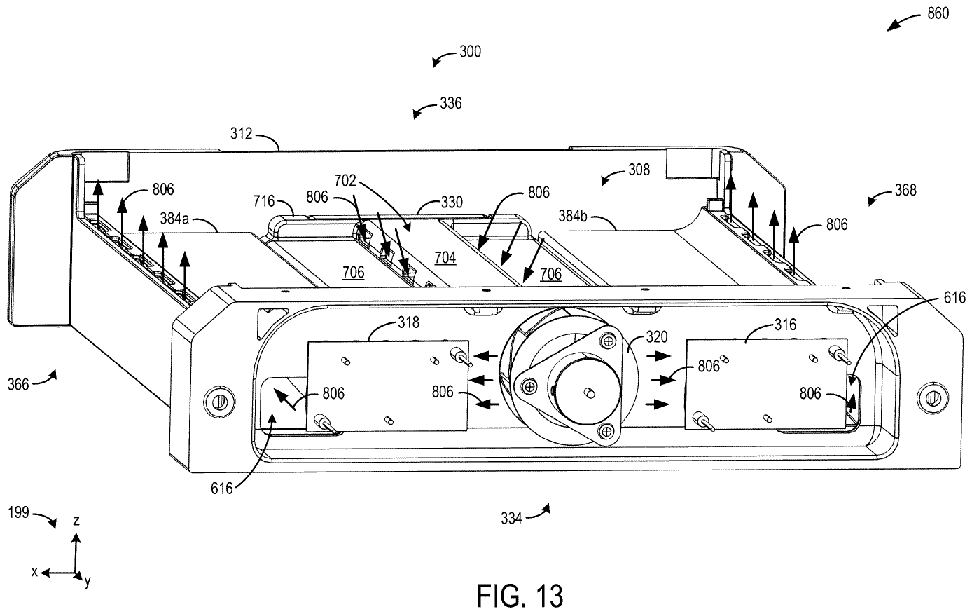

FIG. 5 shows a view of the incubator heating system 300 where the end cap 338 is omitted to show arrangement of elements of the heat engine assembly 304 in the incubator heating system 300. The heat engine assembly 304 comprises an air mover (e.g., a fan 320) positioned between a first heater 318 and a second heater 316 along a first axis 340 that is perpendicular to a base length 342 of the base 312. One or more of the fan 320, the first heater 318, and the second heater 316 may be permanently and/or removably coupled to the end cap 338 (not shown in FIG. 5). For example, the one or more of the fan 320, the first heater 318, and the second heater 316 may be coupled to the end cap 338 via a weld, a selective fastening device (e.g., a screw, a snap-fit, a press fit), a permanent fastening device (e.g., glue, melting together of elements), and/or by continuous formation with the end cap 338 (e.g., via three-dimensional or other additive manufacturing, via a cast or other mold). Electrical couplings 344 of the heat engine assembly 304 may couple each of the fan 320, the first heater 318, and the second heater 316 to one or more power sources (not shown) that enable each of the fan 320, the first heater 318, and the second heater 316 to be independently and selectively powered. Selective powering of elements of the heat engine assembly 304 is further described with respect to FIGS. 12-13. The base 312 may include coupling elements 372b that are complementary to the coupling elements 372a of the end cap 338 of the incubator heating system 300.

As shown in FIG. 3, the end cap 338 may be positioned between the electrical couplings 344 and the fan 320, the first heater 318, and the second heater 316 of the heat engine assembly 304. Further, electrical couplings 344 may be removed (e.g., uncoupled) from elements of the heat engine assembly 304, and/or from the one or more power sources, during execution of the method for cleaning the incubator heating system 300 described with respect to FIG. 23.

The incubator heating system 300 further comprises a flat tray 346 that is positioned in the middle portion 354 of the base 312 between the first end 334 and the second end 336 of the base 312. The flat tray 346 is an example of a subject support system on which a mattress, a telescoping device, and/or other elements configured to support a subject (e.g., an infant) may be positioned. The flat tray 346 may be positioned in the base 312 at least partially on top of the air ducting system 308, with respect to the z-axis of the axis system 199. A flat tray length 348 of the flat tray 346 may be less than the base length 342 of the base 312. As partially shown in FIG. 4 and further shown in FIG. 7, the flat tray 346 may include a series of toothed gaps 382 along a flat tray width 380 of the flat tray 346 at both the first end 334 and the second end 336. The series of toothed gaps 382 may fluidly couple the infant compartment to the air ducting system 308 (e.g., enable air flow to flow between a space above the flat tray 346, with respect to the z-axis, and an interior of the base 312 in which the air ducting system 308 is positioned, via the series of toothed gaps 382). The flat tray 346 further includes a through hole 376 at the first end 334 and the second end 336. The through hole 376 may function as an additional vent hole through which air can pass to/from an interior of the base 312. In another example, the through hole 376 may be a fastening location at which the flat tray 346 is removably coupled to the base 312.

As briefly described with respect to FIG. 2, the air ducting system 308 comprises two side ducts and a central duct. A first side duct 384a is positioned in the base 312 on the first side 366 and a second side duct 384b is positioned in the base 312 on the second side 368. The first side duct 384a may be an example of the first side duct 222 of FIG. 2. The second side duct 384b may be an example of the second side duct 224 of FIG. 2. The central duct (not shown) is positioned between the first side duct 384a and the second side duct 384b. The flat tray width 380 is less than the first width 358, therefore a portion of each of the first side duct 384a and the second side duct 384b is exposed (e.g., is not covered by the flat tray 346). The side duct length may be approximately equal to the flat tray length 348. The portion of each of the first side duct 384a and the second side duct 384b that is exposed comprises a vent opening 364. The vent opening 364 may be one or more vent holes and/or slots that extend along the first side 366 of the first side duct 384a and the second side 368, opposite the first side 366, of the second side duct 384b. For example, the vent opening 364 may include a series of vent holes that are evenly spaced along a side duct length 378 of each respective side duct of the first side duct 384a and the second side duct 384b, as further described with respect to FIGS. 8-9. The vent opening 364 may fluidly couple the air ducting system 308 to the infant compartment, as further described with respect to FIGS. 12-21.

FIG. 6 shows a perspective view 400 of the heat engine assembly 304 of the incubator heating system 300. As briefly described with respect to FIG. 5, the heat engine assembly 304 comprises the fan 320, the first heater 318, and the second heater 316. Each of the fan 320, the first heater 318, and the second heater 316 may be permanently and/or removably coupled to the end cap 338. As shown in FIG. 6, the first heater 318 and the second heater 316 are each a heating coil. In other examples of the heat engine assembly 304, the first heater 318 and/or the second heater 316 may be a different type of heating element, as described with respect to FIG. 2.

FIG. 7 shows a perspective view 500 of the flat tray 346 of the incubator heating system 300. As briefly described with respect to FIGS. 3-5, the flat tray 346 comprises the series of toothed gaps 382 along the flat tray width 380 of the flat tray 346 at both the first end 334 and the second end 336. The series of toothed gaps 382 may include a series of gaps interspaced between “teeth” that extend from the flat tray 346 towards the first end 334 and the second end 336, parallel to the flat tray length 348 (e.g., parallel to the y-axis of the axis system 199). The series of toothed gaps 382 may be evenly spaced along flat tray width 380 at the first end 334 and the second end 336 of the flat tray 346.

FIGS. 8 and 9 show perspective views 600 and 650, respectively, of the first side duct 384a of the air ducting system 308. It is to be understood that the second side duct 384b has a mirrored configuration to the first side duct 384a across the z-y plane. Thus, description of the first side duct 384a as described with respect to FIGS. 8 and 9 may also be used to describe the second side duct 384b in accordance with a respective axis system. FIGS. 8 and 9 are described simultaneously herein.

As briefly described with respect to FIGS. 3-5 and 7, a side duct length 602 (e.g., the side duct length 378 of FIGS. 3-5) of the first side duct 384a may be approximately equal to the flat tray length 348 of the flat tray 346. The first side duct 384a has a side duct width 604 that is perpendicular to the side duct length 602. The side duct width 604 may be less than the side duct length 602.

The first side duct 384a comprises a first vertical wall 622 on the first side 366, a second vertical wall 624 on the second end 336, and a third vertical wall 626 on the first end 334. Each of the first vertical wall 622, the second vertical wall 624, and the third vertical wall 626 are continuous with a top surface 628 of the first side duct 384a. As is shown in FIG. 9, an open area 630 that is surrounded by the first vertical wall 622, the second vertical wall 624, the third vertical wall 626, and the top surface 628 may be open to air on a bottom side (e.g., opposite the top surface 628, with respect to the z-axis of the axis system 199) and on the second side 368. Air may occupy the open area 630 of the first side duct 384a.

A first portion 606 of the first side duct 384a (e.g., along the side duct width 604) is substantially planar. A second portion 608 of the first side duct 384a is curved (e.g., is concave with respect to the first portion 606). A third portion 610 of the first side duct 384a is substantially planar. The third portion 610 is continuous with the first portion 606 via the second portion 608. The third portion 610 comprises the vent opening 364, as described with respect to FIGS. 3-5. Similar to the series of toothed gaps 382 of the flat tray 346, the vent opening 364 may be toothed extensions with one or more u-shaped gaps therebetween that are equally spaced along an outer edge 612 of the first side duct 384a. The outer edge 612 is an outer edge of each respective side duct that is spaced away from the central duct, as further described with respect to FIGS. 10-11. For example, the vent opening 364 is positioned along the first side 366 for the first side duct 384a, and are positioned along the second side 368 for the second side duct 384b. The third portion 610 may further include vertical protrusions 614 that extend from the substantially planar surface of the third portion 610 (e.g., parallel to the z-axis of the axis system 199). The vertical protrusions 614 may be used to position walls of the infant enclosure of the incubator in which the incubator heating system 300 is implemented, as further described with respect to FIGS. 17-21. A first height 618 at the first end 334 in the first portion 606 of the first side duct 384a is greater than a second height 620 at the second end 336 in the first portion 606. The height of the first side duct 384a gradually decreases from the first height 618 at the first end 334 to the second height 620 at the second end 336. This may assist in directing air flow from the first end 334 to the second end 336.

The vent opening 364 of the first side duct 384a is positioned along the outer edge 612 of the third portion 610. The vent opening 364 creates one or more open spaces in a first plane (e.g., the y-x plane, with respect to the axis system 199). The first side duct 384a comprises an inlet 616 at the first end 334 in a second plane (e.g., the z-x plane, with respect to the axis system 199) that is perpendicular to the first plane. When the first side duct 384a is positioned in the base 312 and the heat engine assembly 304 is coupled to the base 312 at the first end 334, the inlet 616 of the first side duct 384a is axially aligned with at least a portion of the first heater 318, as will be shown in FIGS. 12-13. Air may be directed into the open area 630 of the first side duct 384a by the air mover (e.g., the fan 320) of the heat engine assembly 304 via the inlet 616. Air may flow along the side duct length 602 of the first side duct 384a, and out of the open area 630 of the first side duct 384a via the vent opening 364. A set of arrows 632 in FIG. 9 show an example of potential air flow through the first side duct 384a. Air flow into, through, and out of the second side duct 384b is similarly conducted. In this way, each of the first side duct 384a and the second side duct 384b enable fluid communication between the heat engine assembly 304 and the infant compartment via the inlet 616 and the vent opening 364 of each of the first side duct 384a and the second side duct 384b. The first side duct 384a and the second side duct 384b further enable continuous air flow (e.g., a uniform speed of air flow) throughout the open area 630 of the respective side duct from the first end 334 to the second end 336. This enables uniform heat distribution and a maintained temperature, such that air output by the air ducting system 308 to the infant compartment at the first end 334 is the same temperature as air output by the air ducting system 308 at the second end 336.

FIGS. 10-11 show perspective views 700 and 750, respectively, of the central duct 702 of the air ducting system 308. The central duct 702 may be an example of the central duct 226 of FIG. 2. The central duct 702 comprises a raised middle 704 flanked on the first side 366 and the second side 368 by planar surfaces 706. The raised middle 704 is continuous with the planar surfaces 706. The raised middle 704 may extend approximately one third of a central duct width 708 of the central duct 702. Each of the planar surfaces 706 on the first side 366 and the second side 368 of the raised middle 704 may extend approximately one third of the central duct width 708. Each of the planar surfaces 706 and the raised middle 704 may extend at least a portion of a central duct length 710 of the central duct 702. At the second end 336, the central duct 702 may include a raised cap 714. The raised cap 714 may extend at least a portion of the central duct length 710, and may abut the raised middle 704. The raised cap 714 may have a cap height 716 that is equal to a raised middle height 718 of the raised middle 704. The raised middle height 718 of the raised middle 704 may be the same along the central duct length 710. The raised cap 714 may be configured to abut the fresh air inlet 330 of the base 312, as shown in FIGS. 12-13. The central duct 702 includes a first vertical extension 720 of the raised middle 704 at the first end 334. As will be shown in FIGS. 12-14, the first vertical extension 720 may be in face-sharing contact with the base 312 when the central duct 702 is positioned in the base 312. A first height 722 of the central duct 702 at the first end 334 is more than a second height 724 of the central duct 702 at the second end 336. The height of the central duct 702 gradually decreases from the first end 334 to the second end 336.

The central duct 702 has an approximate “u” shape, where a top surface 726 is formed by the raised middle 704 and the planar surfaces 706. Side walls 728 of the central duct 702 on the first side 366 and the second side 368 are continuous with and perpendicular to the top surface 726. The central duct 702 is open (e.g., has no walls) at the first end 334 and the second end 336. Described another way, the central duct 702 has an outlet 730 at the first end 334 and an inlet 732 at the second end 336. The “u” shape of the central duct 702 forms an open area 712 that is surrounded by the top surface 726 and the side walls 728. The open area 712 may be open to air on a bottom side (e.g., opposite the top surface 726, with respect to the z-axis of the axis system 199), at the first end 334 and at the second end 336. Air may occupy the open area 712 of the central duct 702.

The raised middle 704 includes a vent opening 734 along the first side 366 and the second side 368 of the raised middle 704. In the example of the central duct 702 described herein, the vent opening 734 comprises one or more vent holes. The vent opening 734 is positioned in a second plane (e.g., the z-y plane, with respect to the axis system 199) that is perpendicular to a first plane (e.g., the y-x plane, with respect to the axis system 199) of the planar surfaces 706. Vent holes of the vent opening 734 may be equally spaced along the central duct length 710 of the central duct 702. Spacing and configuration of the multiple vent holes of the vent opening 734 may enable a uniform air flow into the open area 712 and along the central duct length 710 of the central duct 702.

When the central duct 702 is positioned in the base 312, as shown in FIGS. 12-14, the outlet 730 is axially aligned with the fan 320 and the inlet 732 is axially aligned with the fresh air inlet 330 of the base 312. Air may be directed into the open area 712 of the central duct 702 from an area above the top surface 726 of the central duct 702, with respect to the z-axis of the axis system 199 (e.g., the infant compartment) via the vent opening 734. Air may flow into the open area 712 from the fresh air inlet 330 of the base 312 via the inlet 732 at the second end 336. Air may flow out of the open area 712 via the outlet 730. A set of arrows 736 show an example of potential air flow through the central duct 702.

FIGS. 12, 13, and 14 show perspective views 850, 860, and 870 respectively of the incubator heating system 300 with the flat tray 346 removed to show the air ducting system 308 positioned in the base 312. FIG. 13 further shows the incubator heating system 300 with the end cap 338 removed to show elements of the heat engine assembly 304. FIGS. 12-14 are described simultaneously herein.

The first side duct 384a, the central duct 702, and the second side duct 384b of the air ducting system 308 are positioned in the base 312 such that the central duct 702 is positioned between the first side duct 384a and the second side duct 384b, with respect to the x-axis of the axis system 199. The air ducting system 308 extends at least partially along the base length 342 of the base 312 between the first end 334 and the second end 336. For example, each duct of the air ducting system 308 extends along the base length 342, as described with respect to FIGS. 8-11. The first side duct 384a and the second side duct 384b may have a mirrored configuration with respect to each other (e.g., in the y-z plane, with respect to the axis system 199). The inlet 616 of each of the first side duct 384a and the second side duct 384b is axially aligned with at least a portion of the first heater 318 and the second heater 316, respectively.

A set of arrows 806 show an example of potential air flow through the air ducting system 308. Air enters the incubator heating system 300 via the fresh air inlet 330 of the base 312, and flows into the open area 712 of the central duct 702. Air further enters the air ducting system 308 of the incubator heating system 300 via the vent opening 734 of the central duct 702 on each of the first side 366 and the second side 368 of the raised middle 704. Air flows along the central duct length 710 of the central duct 702 in the open area 712 towards the heat engine assembly 304 (e.g., in a direction from the second end 336 to the first end 334). Air is pushed by the fan 320 from the central duct 702 past each of the first heater 318 and the second heater 316. For example, air is pulled by the fan 320 in a direction parallel to the y-axis of the axis system 199, and is pushed in a direction parallel to the x-axis of the axis system 199. Air is heated by each of the first heater 318 and the second heater 316 as the air flows past the heaters. Heated air enters the first side duct 384a and the second side duct 384b via the inlet 616 of each side duct. Heated air is directed out of the respective side duct via the vent opening 364 positioned along the outer edge 612. A configuration of the air ducting system 308 directs a change in air flow direction.

Each of the heat engine assembly 304, the first side duct 384a, the second side duct 384b, and the central duct 702 are independently removable from the base 312. Further, the heat engine assembly 304, the first side duct 384a, the second side duct 384b, and the central duct 702 are removable from the base 312 without removing the flat tray 346. The herein described configuration of the heat engine assembly 304 and the air ducting system 308 facilitate easy removal and cleaning of elements of the incubator heating system 300. The coupling elements 372a of the heat engine assembly 304 may be integrated in (e.g., permanently coupled to) the heat engine assembly 304, and thus may easily be snap fit, screwed, or otherwise fastened into the base 312 without demanding that the coupling elements 372a be stored during cleaning of the heat engine assembly 304. Further, the first side duct 384a, the second side duct 384b, and the central duct 702 may be positioned in the base 312 without the use of fastening and/or coupling elements. Described another way, the first side duct 384a, the second side duct 384b, and the central duct 702 may be positioned in the base 312 and prevented from moving laterally and/or axially within the base 312 by walls of the base 312 and by the heat engine assembly 304 at the first end 334. The vent opening 364 of each of the first side duct 384a and the second side duct 384b, the vent opening 734 of the central duct 702, and the set of toothed gaps 382 and the through holes 376 of the flat tray 346 may reduce and/or prevent buildup of condensation in the heat engine assembly 304, which may reduce a demanded frequency of cleanings.

FIGS. 15-16 show perspective views 900 and 950, respectively, of the base 312 of the incubator heating system 300. As briefly described above, the base 312 includes the fresh air inlet 330 at the second end 336. The base 312 further includes an air mover inlet 920 at the first end 334. The base 312 also includes a first side inlet 922a and a second side inlet 922b at the first end 334 that are positioned on either side of the air mover inlet 920 in the x-z plane, with respect to the axis system 199 (e.g., on the first side 366 and the second side 368 of the air mover inlet 920). When the heat engine assembly 304 is coupled to the base 312 at the first end 334, the fan 320 may be aligned (e.g., along the y-axis, with respect to the axis system 199) with the air mover inlet 920. The first heater 318 and the second heater 316 may be at least partially aligned, with respect to the y-axis, with the first side inlet 922a and the second side inlet 922b, respectively. Elements of the air ducting system 308 may be positioned in an interior 910 of the base 312. For example, the inlet 616 of the first side duct 384a may be aligned along the y-axis with respect to the first side inlet 922a. The inlet 616 of the second side duct 384b may be aligned along the y-axis with respect to the second side inlet 922b. The central duct 702 may be aligned along the y-axis with the fresh air inlet 330 and the air mover inlet 920, where the raised cap 714 is in face-sharing contact with the fresh air inlet 330, and the first vertical extension 720 is in face sharing contact with the air mover inlet 920. The air mover inlet 920 and the fresh air inlet 330 may be axially aligned along a central axis 908 of the base 312.

A bottom 902 of the base 312 may include a first portion 904 that is parallel to and/or planar with respect to the y-x plane. The bottom 902 of the base 312 further includes a second portion 906 that may be positioned at an incline with respect to the y-x plane. The incline of the second portion 906 may gradually reduce a depth of the interior 910 of the base 312 from the first end 334 to the second end 336. For example, at the first end 334 (e.g., in the first portion 904), the interior 910 may have a first depth 914. At the second end 336 (e.g., in the second portion 906), the interior 910 may have a second depth 916. The second depth 916 may be less than the first depth 914. The second portion 906 further includes a channel 912 that extends along a second portion length 918 of the base length 342. The channel 912 may extend below the planar surface of the second portion 906 of the bottom 902 (e.g., with respect to the z-axis of the axis system 199).

FIG. 17 is a first cross-sectioned view 1050 of the incubator heating system 300. The first cross-sectioned view 1050 is segmented along the z-y plane at the central duct 702, such that the open area 712 of the central duct 702 is shown. FIG. 17 further shows an outer wall 1004a and an inner wall 1004b on the first side 366 of the incubator heating system 300. The outer wall 1004a is positioned along the outer edge 612 of the first side duct 384a. The outer wall 1004a may be, for example, a two-paned wall formed of a first pane that is parallel to a second pane. A vacuum may be formed between the first pane and the second pane in some examples. The inner wall 1004b may be parallel to and spaced apart from the outer wall 1004a, such that there is a space 1006 between the inner wall 1004b and the outer wall 1004a. The inner wall 1004b is closer to the flat tray 346 than the outer wall 1004a. It is to be understood that the incubator heating system 300 may further include an inner wall and an outer wall having the same configuration as the inner wall 1004b and the outer wall 1004a on the second side 368, as well as the first side 366, of an infant enclosure (e.g., the infant enclosure 18 of FIG. 1), as further described with respect to FIG. 21. The vent opening 364 of the first side duct 384a is positioned between the inner wall 1004b and the outer wall 1004a.

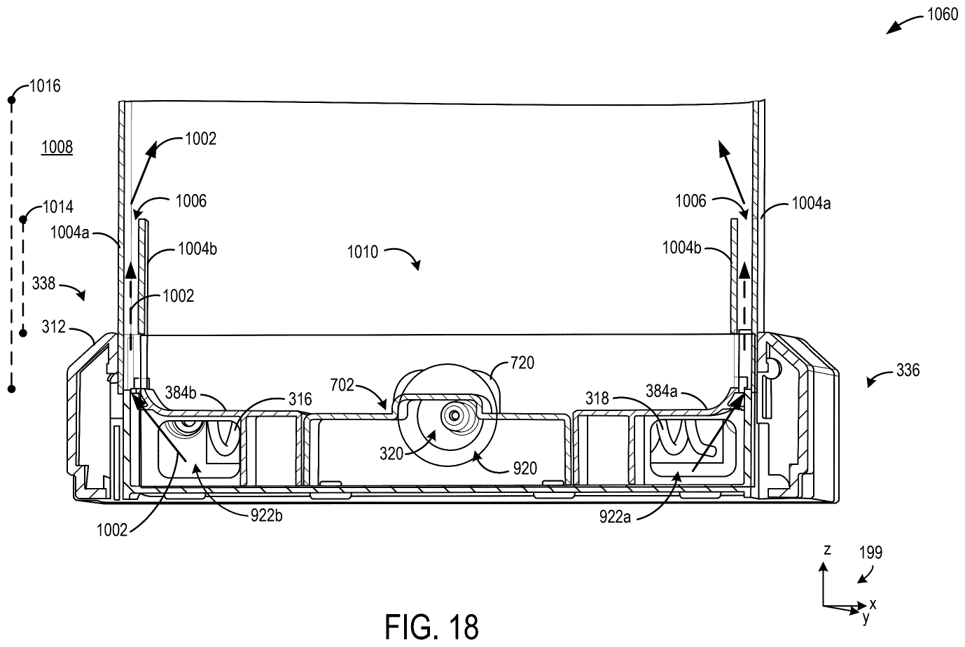

Arrows 1002 show an example air flow path through the incubator heating system 300. Some arrows (e.g., showing air flow out of each vent hole of the vent opening for the central duct 702 and the first side duct 384a) are excluded for clarity, though it is to be understood that air may flow into and/or out of vent holes of the same vent opening for a duct element (e.g., the first side duct 384a, the second side duct 384b, the central duct 702) in the same way. Air flows into the incubator heating system 300 via the fresh air inlet 330 of the base 312. Air flows through the open area 712 of the central duct 702 from the second end 336 to the first end 334. Rotation of the fan 320 may draw air into the central duct 702 via the fresh air inlet 330 and the vent opening 734 of the central duct 702. The fan 320 may continuously draw air into the central duct 702 via the fresh air inlet 330 and the vent opening 734 during operation (e.g., rotation) of the fan. The second portion 906 of the bottom 902 of the base 312, as well as the gradually increasing height of the central duct 702 (e.g., from the second depth 916 to the first depth 914) from the second end 336 to the first end 334 may assist in directing air towards the fan 320. Rotation of the fan 320 further directs air past the first heater 318 and the second heater 316 and into the first side duct 384a and the second side duct 384b, as is further shown in FIG. 18. Heated air (e.g., air heated by the first heater 318) may be directed out of the vent opening 364 (not shown in FIG. 17) of the first side duct 384a and into the space 1006. Arrows 1002 shown as dashed lines illustrate a flow of heated air between the outer wall 1004a and the inner wall 1004b in the space 1006. A second height 1014 of the inner wall 1004b may be less than a first height 1016 of the outer wall 1004a. The inner wall 1004b may thus assist in directing air flow out of the first side duct 384a and the second side duct 384b, and into the infant compartment 1010.

As a two-paned wall, the outer wall 1004a may insulate the infant compartment 1010 from an external environment 1008. The external environment 1008 is a space external to the incubator heating system 300 and to the incubator (e.g., the environment 38 of the incubator 10 of FIG. 1) in which the incubator heating system 300 is positioned. The external environment 1008 may be, for example, a hospital room or other medical care setting. Air in the external environment 1008 may be cooler than a desired air temperature for an infant compartment 1010 (e.g., the infant compartment 24 of FIG. 1). The two-paned wall of the outer wall 1004a may provide an additional layer of insulation (e.g., the first pane and the second pane), compared to a single-paned wall. The additional layer of insulation may reduce heat loss, thus increasing the efficiency of the insulator heating system 300 compared to a conventional insulator heating system having a single-paned wall.

Air that is taken into the air ducting system 308 via the fresh air inlet 330 may be air from the external environment 1008. Air taken into the air ducting system 308 via the vent opening 734 of the central duct 702 may be air from the infant compartment 1010. It may be desirable to circulate air through the infant compartment 1010 to direct the flow of oxygen into the infant compartment 1010, and direct the flow of carbon dioxide and potential particulates in the air out of the infant compartment 1010. Further, air in the infant compartment 1010 may be a temperature that is less than a desirable temperature for air in the infant compartment 1010, where the desirable temperature may stimulate and/or support infant development.

FIG. 18 is a second cross-sectioned view 1060 of the incubator heating system 300. The second cross-sectioned view 1060 is segmented along the z-x plane, with respect to the axis system 199. As described with respect to FIG. 17, rotation of the fan 320 pulls air through the central duct 702 towards the first end 334 (e.g., towards the fan 320). The raised middle 704, as well as the first vertical extension 720, of the central duct 702 may direct air into the fan 320 (e.g., in between rotating blades of the fan 320). Rotation of the fan 320 further directs air past the first heater 318 and the second heater 316 and into the first side duct 384a and the second side duct 384b, as illustrated by arrows 1002. Heated air is directed out of the vent opening 364 of the first side duct 384a and the second side duct 384b and into the space 1006 between the outer wall 1004a and the inner wall 1004b on each of the first side 366 and the second side 368.

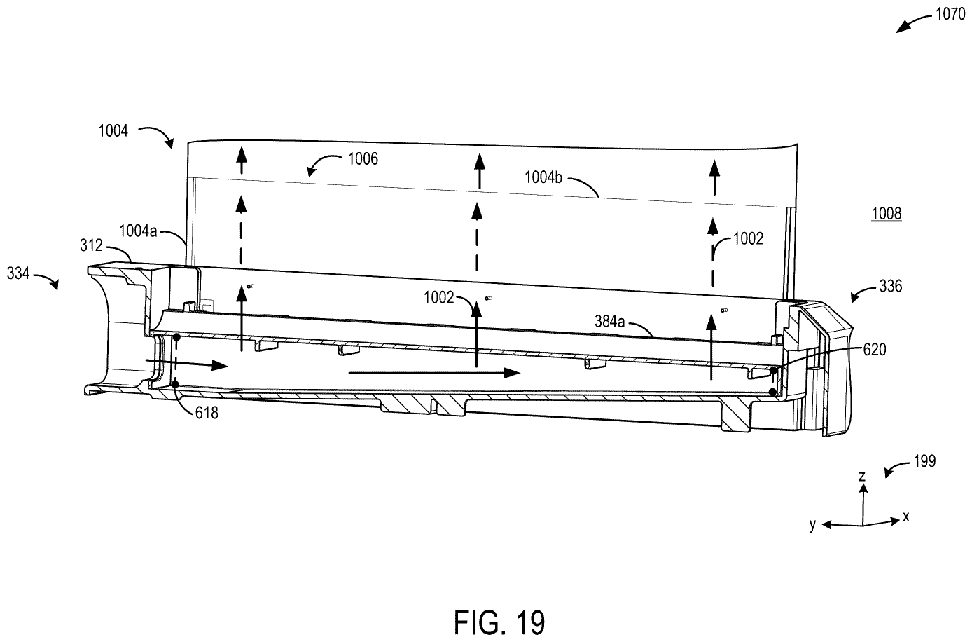

FIG. 19 is a third cross-sectioned view 1070 of the incubator heating system 300. The third cross-sectioned view 1070 is segmented along the z-y plane at the first side duct 384a, such that the open area 630 of the first side duct 384a is shown. Rotation of the fan 320 directs air past the first heater 318 and the second heater 316 and into the open area 630 of the first side duct 384a. Similar to the central duct 702, and as described with respect to FIGS. 8-9, the height of the first side duct 384a gradually decreases from the first height 618 at the first end 334 to the second height 620 at the second end 336. This may assist in directing air flow from the first end 334 to the second end 336. Heated air is directed out of the vent opening 364 of the first side duct 384a and into the space 1006 between the outer wall 1004a and the inner wall 1004b each of the first side 366 and the second side 368. Air is similarly directed through and out of the second side duct 384b, as described with respect to the first side duct 384a.

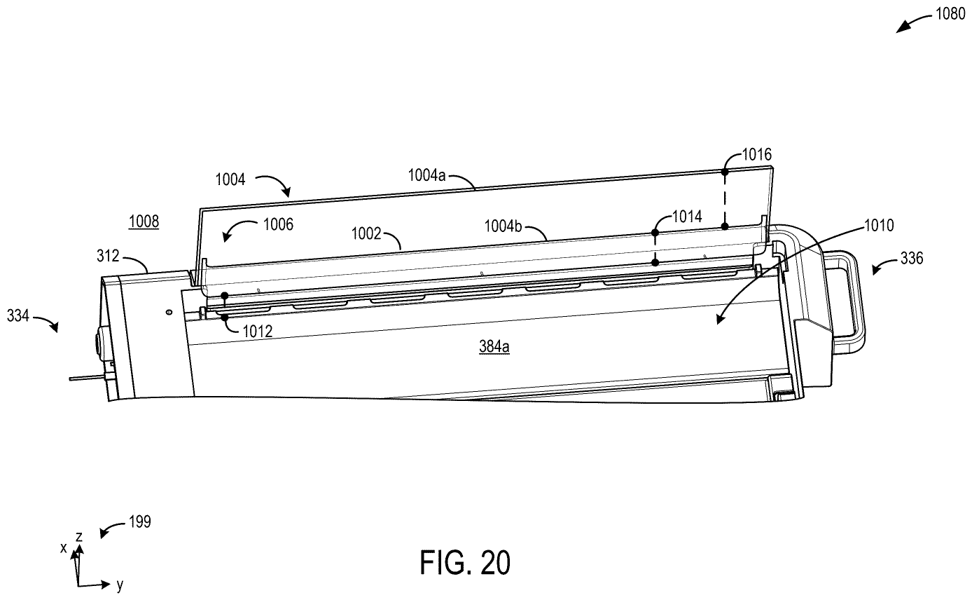

FIG. 20 is a fourth perspective view 1080 of the incubator heating system 300 that shows placement of the outer wall 1004a and the inner wall 1004b with respect to the first side duct 384a. In the embodiment shown in FIG. 20, the inner wall 1004b may be positioned a height 1012 above the first side duct 384a, such that the inner wall 1004b is not in contact with the first side duct 384a. The inner wall 1004b may thus assist in directing air flow out of the first side duct 384a and into the infant compartment 1010. The outer wall 1004a may be in contact with the base 312 such that there is no gap between the base 312 and the outer wall 1004a through which air may enter and/or escape the infant compartment 1010.

FIG. 21 shows a fifth perspective view 1100 of the incubator heating system 300. The fifth perspective view 1100 shows the outer wall 1004a and the inner wall 1004b on both the first side 366 and the second side 368 of the incubator heating system 300. The outer wall 1004a and the inner wall 1004b on each of the first side 366 and the second side 368, as well as walls (not shown) on the first end 334 and the second end 336 of the incubator heating system 300 may enclose the infant compartment 1010. Air transfer between the infant compartment 1010 and the external environment 1008 may occur at the fresh air inlet 330. The flat tray 346 is positioned on top of, with respect to the z-axis, the air ducting system 308 (e.g., the first side duct 384a, the second side duct 384b, and the central duct 702). Air transfer from the infant compartment 1010 to the central duct 702 includes air being drawn by the fan 320 through the through hole 376 and the series of toothed gaps 382 of the flat tray 346 at the first end 334 and the second end 336. Air flows into the open area 712 of the central duct 702 via the vent opening 734 of the central duct 702, as described above.

FIG. 22 is a flow chart of a method 1200 for operating the incubator heating system. The method 1200 may be executed by a user, such as a healthcare provider. The method 1200 may additionally or alternatively be executed by a computing device, automatically and/or in response to receiving a user input. For example, the method 1200 may be stored in a memory of a controller that is communicably coupled to elements of the heat engine assembly and one or more sensors of the infant compartment. The method 1200 is described herein with respect to the incubator heating system 300 of FIGS. 3-11, which may be implemented in the incubator 10 of FIG. 1 and/or the incubator 200 of FIG. 2.

At 1202, the method 1200 includes monitoring incubator operating conditions. Conditions may include a temperature, a humidity, and so on within the infant compartment. Monitoring incubator operating conditions may include identifying conditions at which incubator operation is presently operating. Operating conditions may be set by a user input. The incubator may include one or more sensors configured to detect a temperature, a humidity, and so on within the infant compartment. The sensors are communicably coupled to the controller. In some examples, the controller is coupled to a display that is configured to output a view that indicates incubator operating conditions. For example, the display may be mounted on and/or integrated in the incubator, and/or the display may be a separate device that is communicably coupled to the incubator, such as a mobile device (e.g., a laptop, a smartphone, a tablet) and/or a workstation.

At 1204, the method 1200 includes determining if an infant compartment temperature is less than a threshold temperature. The controller may receive a signal from the sensor (e.g., a temperature sensor) indicating that the infant compartment temperature is less than the threshold temperature. In response to the infant compartment temperature not being less than (e.g., being greater than) the threshold temperature (NO at 1204), the method 1200 returns to operation 1202 to monitor incubator operating conditions. In response to the infant compartment temperature being less than the threshold temperature (YES at 1204), the method 1200 proceeds to actuate a heat engine assembly at 1206. Actuating the heat engine assembly comprises actuating one or more heating elements of the heat engine assembly to heat air at 1207. At 1210, actuating the heat engine assembly further comprises actuating an air mover (e.g., a fan) of the heat engine assembly to draw unheated air into the air ducting system via a central duct of an air ducting system, and push heated air through side ducts of the air ducting system. Unheated air is drawn by the air mover into a central duct of the air ducting system via a fresh air inlet of the base, a vent opening of the central duct, and through holes of the flat plate. The air mover directs air from the central duct laterally (e.g., in a direction perpendicular to the base length and the length of the air ducting system) such that unheated air flows past each of the first heater and the second heater and is heated thereby. Geometry of the air ducting system and the heat engine assembly direct heated air into each of the first side duct and the second side duct. Heated air flows along the length of each of the side ducts and out of the side ducts via the vent opening along the outer edge of each side duct. In some examples, heated air flows out of the side ducts into the infant compartment. Additionally or alternatively, heated air flows out of the side ducts into walls of the incubator (e.g., between two wall panels that make up a side wall of the incubator). In this way, air is continuously drawn in from the infant compartment and from an external environment by the air mover to be heated by the heat elements and cycled back into the infant compartment as heated air. Fresh air from the external environment and air from the infant compartment mixes in the central duct.

At 1212, the method 1200 includes determining if the infant compartment temperature is greater than the threshold temperature. In response to the infant compartment temperature not being greater than the threshold temperature (NO at 1212), the method 1200 proceeds to 1214 to maintain the heat engine assembly in the actuated state. The method 1200 returns from 1214 to 1212 to determine if the infant compartment temperature is greater than the threshold temperature.

In response to the infant compartment temperature being greater than the threshold temperature (YES at 1212), the method 1200 proceeds to 1216 to deactivate the heat engine assembly. The method 1200 ends.

FIG. 23 is a flow chart of a method 1300 for cleaning the incubator heating system. The method 1300 may be executed by a user, such as a janitor, in some examples. The method 1300 may additionally or alternatively be executed by a non-human user, such as a robot comprising memory that stores the method 1300, a processor configured to execute the stored method, and one or more appendages configured to handle elements of the incubator heating system. The method 1300 is described herein with respect to the incubator heating system 300 of FIGS. 3-21, which may be implemented in the incubator 10 of FIG. 1 and/or the incubator 200 of FIG. 2.

At 1302, the method 1300 includes removing a heat engine assembly comprising one or more heat elements and an air mover (e.g., a fan) mounted on an end cap from a first end of an incubator without removing a subject support system from the incubator. Removing the heat engine assembly may include removing fastening devices that are configured to couple the heat engine assembly to a base of the incubator heating system, such as screws, bolts, clips, and/or other suitable fastening devices. Removing the heat engine assembly from the incubator further comprises, at 1304, removing and/or disconnecting electrical couplings from the heat engine assembly.

At 1306, the method 1300 includes removing an air ducting system of the incubator heating system from the first end of the base without removing the subject support system. Removing the air ducting system comprises, at 1307, removing a first side duct, a second side duct, and a central duct (e.g., the first side duct 384a, the second side duct 384b, and the central duct 702 of FIGS. 12-14) of the air ducting system from the base. Because the first side duct, the second side duct, and the central duct are individual linear channels that may be independently removed from the base, removal and cleaning of the air ducting system may be performed more easily than in conventional air ducting systems, such as those having serpentine ducts, flow paths that are permanently coupled to the base of the incubator heating system, and/or include multiple flow directing elements that are coupled to the base via coupling elements.

At 1310, the method 1300 includes cleaning the heat engine assembly and the air ducting system. At 1312, cleaning the heat engine assembly and the air ducting system further comprises optionally submerging the heat engine assembly and/or the air ducting system in a cleaning solution. At 1314, cleaning the heat engine assembly and the air ducting system comprises additionally or alternatively wiping the heat engine system and/or the air ducting system with a cleaning solution. Other methods for cleaning the heat engine assembly and the air ducting system may be implemented without departing from the scope of the present disclosure.

At 1316, the method 1300 comprises inserting the air ducting system into the base via the first end. The air ducting system may be inserted such that an inlet of the first side duct (e.g., the inlet 616 of the first side duct 384a of FIGS. 3-5) and the inlet of the second side duct (e.g., the inlet 616 of the second side duct 384b of FIGS. 3-5) are axially aligned with side inlets of the base (e.g., the first side inlet 922a and the second side inlet 922b, respectively, of FIGS. 15-16), the outlet of the central duct (e.g., the outlet 730 of the central duct 702 of FIGS. 10-11) is aligned with the air mover inlet of the base (e.g., the air mover inlet 920 of FIGS. 15-16), and the inlet of the central duct (e.g., the inlet 732 of the central duct 702 of FIGS. 10-11) is aligned with the fresh air inlet of the base (e.g., the fresh air inlet 330 of the base 312 of FIGS. 3-5).

At 1317, the method 1300 comprises inserting the heat engine assembly into the incubator via the first end. In examples where fastening devices are used, fastening devices are reattached to couple the heat engine assembly to the base of the incubator. At 1320, the method 1300 includes attaching electrical components to the heat engine assembly. The method 1300 ends.

In this way, air in the infant compartment of the incubator may be heated and recirculated by the incubator heating system, while also mixing with air that is taken in from the external environment while the air mover is actuated to move air (e.g., the fan is rotating). Further, the simplified design of the incubator heating system enables the heat engine assembly and the air ducting system to be removed for cleaning without demanding removal of a subject support system. Compared to conventional incubators and incubator heating systems, the disclosed incubator heating system has fewer, less complex, and larger components.

The technical effect of the disclosed incubator heating system is that a cleaning time of the incubator may be reduced, thereby decreasing a time the incubator is offline/not available for use. Cleanability of the incubator may additionally be increased.

The disclosure also provides support for an incubator heating system, comprising: a base comprising a fresh air inlet, an air ducting system that extends along a base length of the base, wherein the air ducting system comprises a first side duct, a second side duct, and a central duct, and each duct of the air ducting system comprises a vent opening, and a heat engine assembly removably coupled to the base at a first end, opposite a second end of the base at which the fresh air inlet is positioned, where the heat engine assembly comprises a fan positioned between a first heater and a second heater along a first axis that is perpendicular to the base length, and wherein the fan is configured to pull air into the central duct via the fresh air inlet and the vent opening of the central duct, direct air from the central duct past each of the first heater and the second heater to heat the air, and direct heated air through the first side duct and the second side duct and out of each of the vent opening of the first side duct and the second side duct. In a first example of the system, the vent opening of each of the first side duct and the second side duct includes one or more vent holes that are positioned in a first plane along an outer edge of the first side duct and the second side duct. In a second example of the system, optionally including the first example, each of the first side duct and the second side duct comprise an inlet in a second plane of the first side duct and the second side duct that is perpendicular to the first plane, where the inlet is positioned at the second end and is axially aligned with at least a portion of the first heater or the second heater. In a third example of the system, optionally including one or both of the first and second examples, the vent opening of the central duct are positioned along a first side and a second side of a raised middle of the central duct, the central duct further comprising an outlet at the first end that is axially aligned with the fan, and an inlet at the second end that is axially aligned with the fresh air inlet of the base. In a fourth example of the system, optionally including one or more or each of the first through third examples, each of the heat engine assembly, the first side duct, the second side duct, and the central duct are independently removable from the base. In a fifth example of the system, optionally including one or more or each of the first through fourth examples, the system further comprises: a flat tray having at each of the first end and the second end of the flat tray a series of toothed gaps and a through hole, where the flat tray is positioned in the base on top of the air ducting system. In a sixth example of the system, optionally including one or more or each of the first through fifth examples, the heat engine assembly and the air ducting system are configured to be selectively removed from the base without removal of the flat tray. In a seventh example of the system, optionally including one or more or each of the first through sixth examples, a height of an open area of each of the air ducting system gradually decreases from the first end to the second end. In an eighth example of the system, optionally including one or more or each of the first through seventh examples, the first heater and the second heater each include a heating coil.

The disclosure also provides support for an incubator, comprising: an infant enclosure defining an infant compartment, an incubator heating system pneumatically coupled with the infant compartment, where the incubator heating system comprises: a heat engine assembly positioned in a base of the infant enclosure at a first end of the infant enclosure, where the heat engine assembly comprises a heat element configured to heat air, and an air mover configured to facilitate transfer of heat through air to selectively transfer heat to the infant compartment, an air ducting system comprising: a fresh air inlet positioned at a second end of the infant enclosure, a central duct being in fluid communication among the fresh air inlet, the infant compartment, and the heat engine assembly via an inlet, an outlet, and a vent opening of the central duct, and a first side duct and a second side duct each being in fluid communication between the heat engine assembly and the infant compartment via a vent opening of each of the first side duct and the second side duct, and a controller operatively coupled to the incubator heating system, wherein the controller is configured to control a temperature of the heat element and a speed and direction of the air mover in response to changes in an air temperature of the infant compartment. In a first example of the system, the heat engine assembly and the air ducting system are independently removable from the infant enclosure. In a second example of the system, optionally including the first example, the incubator heating system further comprises an outer wall and an inner wall on a first side of the infant enclosure and on a second side of the infant enclosure, where the outer wall is a two-paned wall formed of a first pane that is parallel to a second pane with a vacuum therebetween, and wherein the heat engine assembly is configured to selectively transfer heat to the infant compartment by directing heated air from the first side duct and the second side duct into a space between the inner wall and the outer wall via the vent opening. In a third example of the system, optionally including one or both of the first and second examples, the system further comprises: a flat tray having toothed gaps along the first end and the second end, the flat tray positioned on top of the air ducting system. In a fourth example of the system, optionally including one or more or each of the first through third examples, the system further comprises: a thermal sensor positioned in the infant compartment, the thermal sensor configured to measure the air temperature in the infant compartment. In a fifth example of the system, optionally including one or more or each of the first through fourth examples, the controller is configured to actuate the heat element to heat air and actuate the air mover to intake air to be heated via the fresh air inlet and the vent opening of the central duct, and to further direct air out of the vent opening of the first side duct and the second side duct and into the infant compartment.

The disclosure also provides support for a method, comprising: uncoupling coupling elements of a heat engine assembly from coupling elements of a base and sliding the heat engine assembly out of a first end of the base, the heat engine assembly comprising a heat element and an air mover mounted on an end cap, sliding an air ducting system out from the first end of the base, cleaning the heat engine assembly and the air ducting system, inserting the air ducting system into the base via the first end, and inserting the heat engine assembly into the base via the first end, wherein the heat engine assembly and the air ducting system are removed from the base without removing a subject support system of the base. In a first example of the method, the method further comprises: removably coupling electrical couplings to the heat engine assembly. In a second example of the method, optionally including the first example, removing the air ducting system comprises removing a first side duct, a second side duct, and a central duct of the air ducting system from the base. In a third example of the method, optionally including one or both of the first and second examples, cleaning the heat engine assembly and/or air ducting system comprising submerging the heat engine assembly and/or air ducting system in a cleaning solution. In a fourth example of the method, optionally including one or more or each of the first through third examples, cleaning the heat engine assembly and/or air ducting system comprising wiping the heat engine assembly and/or air ducting system with a cleaning solution.

FIGS. 1-11 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example.

As used herein, an element or step recited in the singular and preceded with the word “a” or “an” should be understood as not excluding plural of said elements or steps, unless such exclusion is explicitly stated. Furthermore, references to “one embodiment” of the invention do not exclude the existence of additional embodiments that also incorporate the recited features. Moreover, unless explicitly stated to the contrary, embodiments “comprising,” “including,” or “having” an element or a plurality of elements having a particular property may include additional such elements not having that property. The terms “including” and “in which” are used as the plain-language equivalents of the respective terms “comprising” and “wherein.” Moreover, the terms “first,” “second,” and “third,” etc. are used merely as labels, and are not intended to impose numerical requirements or a particular positional order on their objects.

This written description uses examples to disclose the invention, including the best mode, and also to enable a person of ordinary skill in the relevant art to practice the invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

1. An incubator heating system, comprising:
a base comprising a fresh air inlet;
an air ducting system that extends along a base length of the base, wherein the air ducting system comprises a first side duct, a second side duct, and a central duct, and each duct of the air ducting system comprises a vent opening; and
a heat engine assembly removably coupled to the base at a first end, opposite a second end of the base at which the fresh air inlet is positioned, where the heat engine assembly comprises a fan positioned between a first heater and a second heater along a first axis that is perpendicular to the base length, and wherein the fan is configured to pull air into the central duct via the fresh air inlet and the vent opening of the central duct, direct air from the central duct past each of the first heater and the second heater to heat the air, and direct heated air through the first side duct and the second side duct and out of each of the vent opening of the first side duct and the second side duct.

2. The incubator heating system of claim 1, wherein the vent opening of each of the first side duct and the second side duct includes one or more vent holes that are positioned in a first plane along an outer edge of the first side duct and the second side duct.

3. The incubator heating system of claim 2, wherein each of the first side duct and the second side duct comprise an inlet in a second plane of the first side duct and the second side duct that is perpendicular to the first plane, where the inlet is positioned at the second end and is axially aligned with at least a portion of the first heater or the second heater.

4. The incubator heating system of claim 1, wherein the vent opening of the central duct are positioned along a first side and a second side of a raised middle of the central duct, the central duct further comprising an outlet at the first end that is axially aligned with the fan, and an inlet at the second end that is axially aligned with the fresh air inlet of the base.

5. The incubator heating system of claim 1, wherein each of the heat engine assembly, the first side duct, the second side duct, and the central duct are independently removable from the base.

6. The incubator heating system of claim 1, further comprising a flat tray having at each of the first end and the second end of the flat tray a series of toothed gaps and a through hole, where the flat tray is positioned in the base on top of the air ducting system.

7. The incubator heating system of claim 6, wherein the heat engine assembly and the air ducting system are configured to be selectively removed from the base without removal of the flat tray.

8. The incubator heating system of claim 1, wherein a height of an open area of each of the air ducting system gradually decreases from the first end to the second end.

9. The incubator heating system of claim 1, wherein the first heater and the second heater each include a heating coil.

10. An incubator, comprising:
an infant enclosure defining an infant compartment;
an incubator heating system pneumatically coupled with the infant compartment, where the incubator heating system comprises:
a heat engine assembly positioned in a base of the infant enclosure at a first end of the infant enclosure, where the heat engine assembly comprises a heat element configured to heat air, and an air mover configured to facilitate transfer of heat through air to selectively transfer heat to the infant compartment;
an air ducting system comprising:
a fresh air inlet positioned at a second end of the infant enclosure;
a central duct being in fluid communication among the fresh air inlet, the infant compartment, and the heat engine assembly via an inlet, an outlet, and a vent opening of the central duct; and
a first side duct and a second side duct each being in fluid communication between the heat engine assembly and the infant compartment via a vent opening of each of the first side duct and the second side duct; and
a controller operatively coupled to the incubator heating system, wherein the controller is configured to control a temperature of the heat element and a speed and direction of the air mover in response to changes in an air temperature of the infant compartment.

11. The incubator of claim 10, wherein the heat engine assembly and the air ducting system are independently removable from the infant enclosure.

12. The incubator of claim 10, wherein the incubator heating system further comprises an outer wall and an inner wall on a first side of the infant enclosure and on a second side of the infant enclosure, where the outer wall is a two-paned wall formed of a first pane that is parallel to a second pane with a vacuum therebetween, and wherein the heat engine assembly is configured to selectively transfer heat to the infant compartment by directing heated air from the first side duct and the second side duct into a space between the inner wall and the outer wall via the vent opening.

13. The incubator of claim 10, further comprising a flat tray having toothed gaps along the first end and the second end, the flat tray positioned on top of the air ducting system.

14. The incubator of claim 10, further comprising a thermal sensor positioned in the infant compartment, the thermal sensor configured to measure the air temperature in the infant compartment.

15. The incubator of claim 14, wherein the controller is configured to actuate the heat element to heat air and actuate the air mover to intake air to be heated via the fresh air inlet and the vent opening of the central duct, and to further direct air out of the vent opening of the first side duct and the second side duct and into the infant compartment.

16. A method, comprising:
uncoupling coupling elements of a heat engine assembly from coupling elements of a base and sliding the heat engine assembly out of a first end of the base, the heat engine assembly comprising a heat element and an air mover mounted on an end cap;
sliding an air ducting system out from the first end of the base;
cleaning the heat engine assembly and the air ducting system;
inserting the air ducting system into the base via the first end; and
inserting the heat engine assembly into the base via the first end, wherein the heat engine assembly and the air ducting system are removed from the base without removing a subject support system of the base.

17. The method of claim 16, further comprising removably coupling electrical couplings to the heat engine assembly.

18. The method of claim 16, wherein removing the air ducting system comprises removing a first side duct, a second side duct, and a central duct of the air ducting system from the base.

19. The method of claim 16, wherein cleaning the heat engine assembly and/or air ducting system comprising submerging the heat engine assembly and/or air ducting system in a cleaning solution.

20. The method of claim 16, wherein cleaning the heat engine assembly and/or air ducting system comprising wiping the heat engine assembly and/or air ducting system with a cleaning solution.
